(19) United States
(12) Patent Application Publication
(10) Pub. No.: US 2008/0320031 A1
(43) Pub. Date: Dec. 25, 2008

(54) METHOD AND DEVICE FOR ANALYZING AN EXPRESSION TO EVALUATE

(75) Inventor: Franck Denoual, Saint Domineuc (FR)

Correspondence Address: FITZPATRICK CELLA HARPER & SCINTO, 30 ROCKEFELLER PLAZA, NEW YORK, NY, 10112, US

(73) Assignee: C/O CANON KABUSHIKI KAISHA, Tokyo (JP)

(21) Appl. No.: 12/141,729

(22) Filed: Jun. 18, 2008

(30) Foreign Application Priority Data
Jun. 19, 2007 (FR) 0755867
Nov. 22, 2007 (FR) 0759237

(51) Int. Cl. G06F 7/00; G06F 17/30

(52) U.S. Cl. 707/102; 707/E17.009

(57) ABSTRACT

The method of analyzing an XPath expression composed of sub-expressions to evaluate with respect to a structured document comprises:
a step of classifying the sub-expressions of said expression into a subset comprising calculation sub-expressions and a subset comprising navigation sub-expressions and
a step of linking each navigation sub-expression to the calculation sub-expression that uses it.

The present invention concerns a method and device for analyzing an expression to evaluate, an evaluating method, a computer program and an information carrier. It relates, in particular, to providing an efficient representation of XPath requests for them to be evaluated when streaming.

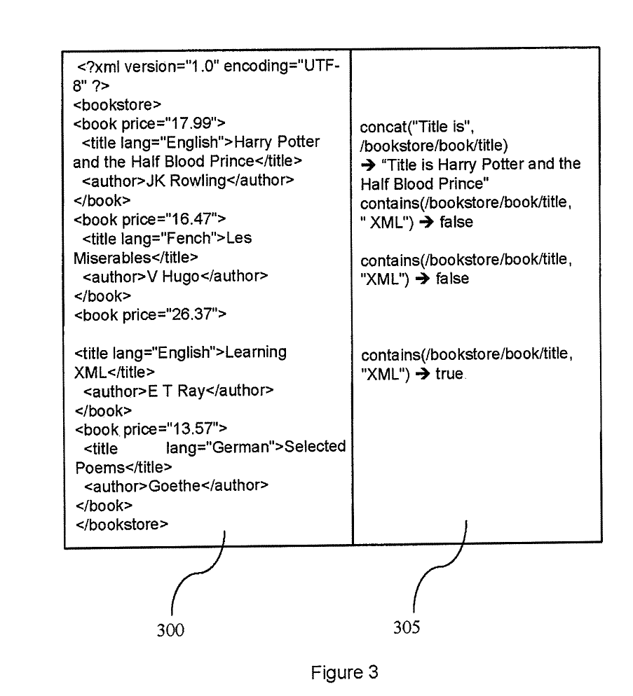

XPath (abbreviation of “XML Path Language”) is a specification of the W3C (acronym for “World Wide Web Consortium”). The object of this specification is to define a syntax for addressing the parts of an XML document. This syntax uses a similar notation to the path expressions in a file system (for example, in the example of an XML document 300 and of expressions 305 in FIG. 3, “/bookstore/book”). XPath defines four types of data: “string”, “Boolean”, “number” and “set of nodes” as well as expressions enabling these data to be manipulated (operators “=”, “!=”, “<”, “>”, etc.). An XPath node may represent different types of XML event: root for the start of the document, element, attribute, text, comment, “processing-instruction” and “namespace”. This syntax serves as a basis for the formation of requests concerning documents for the purpose of their transformation (XSL transformation or “XSLT”), for rapidly accessing sub-parts (“XPointer”) or performing processing operations on parts of the document (“XQuery”). The main advantage of XPath is to simplify the development of applications called upon to navigate within XML documents. The entity responsible for the evaluation of an XPath expression is termed “XPath Processor”. As inputs the XPath processor generally accepts one or more XPath expressions, and a reference concerning XML data (read in a file or received via a network transmission) in relation to which the expression or expressions must be evaluated.

The following paragraph describes the characteristics of the XPath 1.0 specification that are useful for the proper understanding of the invention. It is to be noted that the XPath 1.0 specification is given here by way of example to facilitate the understanding of the invention. The invention also applies with other versions of the XPath syntax, for example XPath 2.0. As mentioned in the introduction, XPath defines four types of data as well as seven types of nodes. The XPath syntax also defines a grammar describing the rules of construction for the different expression and sub-expressions. XPath expressions may be grouped together into two sub-categories which will be designated here as:

the “navigation Expressions”: these are expressions which yield an ordered list of XPath nodes, essentially “LocationPaths” and “Steps” which correspond to the specification of a path to resolve in an XML document and

“calculation Expressions”:
a. Expressions yielding Boolean: “OrExpr”, “AndExpr”, “RelativeExpr”, “EqualityExpr”,
b. Expressions yielding a number: “AdditiveExpr”, “MultiplicativeExpr” and
c. Expressions yielding any type: “FilterExpr” and, in particular, “FunctionCalls”.

The invention is essentially concerned with expressions composed of both types of sub-expression, for example a function call of which at least one of the parameters is expressed by a “LocationPath”.

As regards the organization of the “LocationPaths”, a “LocationPath” may be absolute or relative depending on whether it starts with “/” or not. In the case of an absolute “LocationPath”, the search starts from the root of the document whereas in the case of relative “LocationPaths”, the search is contextual (for example from the current node).

Any “LocationPath” is composed of “Steps”. This level of decomposition is the key level for the evaluation of “LocationPaths” since it may be matched with a depth level in the XML document. For example, in FIG. 3, the expression “/bookstore/book” contains two “Steps” which are: “bookstore” (searched for at depth 1) and “book” (searched for at depth 2).

As regards the organization of the “Steps”, the evaluation of a “Step” is made conditionally on the parent “Step”, that is to say the “Step” which precedes it in the expression. The result of the evaluation of a “Step” thus supplies the evaluation context for the following “Step”. This context is composed of a context node, with a position and a size: the context node is the solution node of the preceding “Step”, the position indicates the rank of the solution node of the current “Step” among its siblings, the size of the context indicates the number of solution nodes of the current “Step”. Any expression of Step type is composed of one to three entities, among which:

an optional “AxisSpecifier” (of which the value is “child” by default), describes the relationship between the context node and the solution nodes of the “Step”. The “AxisSpecifier” is a key-word from among thirteen that are predefined by the XPath syntax, followed by “::”. For example, “/a/child::b” or “/a/attribute::b” respectively mean that what is searched for is a node “b” child of a node “a” and an attribute node “b” child of a node “a”. The thirteen “AxisSpecifiers” defined by the specification are the following:
“self”, “child”, “attribute” (or @”), “namespace”, “descendant”, “descendant-or-self”, “following” and “following-sibling” which are considered as “forward axes” and
“parent”, “ancestor”, “ancestor-or-self”, “preceding” and “preceding-sibling”, which are considered as “backward axes” or “reverse axes”.

a “NodeTest”, which is mandatory, defines the constraint of “(node( )”, “text( )”, “comment( )” or “processing-instruction( ))” type or name (prefix+name) type that the nodes must comply with to be considered as a solution of the “Step”. For example, the expression “/child::b” imposes a constraint of name whereas the expression “/descendant::comment( )” makes it possible to search for all the nodes of comment type.

a “Predicate”, which is optional, enables supplementary conditions to be imposed for the search for solution nodes. A “predicate” expression is signaled by square brackets: “[ . . . ]” and follows the same rules of construction as any XPath expression. For example, “/a/b[2]” makes it possible to select all the second children “b” of each element “a”; “/a/b[@id=“3”]” makes it possible to select the children “b” of “a” having an attribute “id” having a value equal to 3.

As described above, XPath enables parts of an XML document to be accessed. A simple implementation of an XPath processor would consist of constructing an intermediate representation of the XML document in a form which would facilitate the search, a DOM tree (DOM being an acronym for “document object model”) for example, and of going through that tree as many times as necessary for the extraction of the requested nodes. Such an approach poses a double problem.

First of all, it may prove costly in terms of memory in the case of large XML documents. More particularly, considering an XPath processor embedded in a dedicated apparatus (of camera, photocopier or other type), the resources are limited. Attention must be paid to evaluating the XPath expressions progressively as the XML data become available while having the least possible recourse to the storage of those data.

The second problem lies in the multiple traversals made in the tree in search for the solutions. In a context of processing XML data in a streaming environment, it cannot be envisaged to go through the data several times, especially if those data come from an exchange of messages between apparatuses communicating via a network (case of “Web services”, for example).

It is thus appropriate to define a representation of the XPath expressions so as to prepare and to facilitate not only their evaluation in an XML data reception streaming environment, but also the sending of the results to the application as soon as they are available.

Solutions are found in the state of the art making it possible to evaluate XPath expressions of “navigation expression” type in a streaming environment. For example, the document U.S. Pat. No. 7,171,407 describes a representation of navigation expressions in the form of a directed acyclic graph. In this representation, each “NodeTest” of the “Steps” of the “LocationPaths” corresponds to a vertex (or node) of the graph, the “AxisSpecifiers” being represented by the arcs of the graph. The main advantage of this representation is to organize the search for XML information in the order of the document. More particularly, if the “AxisSpecifiers” of “parent” or “ancestor” type are present in the “LocationPaths” to evaluate, the corresponding “NodeTests” are exclusively organized according to a descendancy relationship, that is to say respecting the order of the document.

However, although this representation may prove valuable for XPath expressions that are purely navigational, it does not make it possible to deal with expressions of calculation type or hybrid type (mixing navigations and calculation). Furthermore, this representation requires keeping storage structures for the XPath solution nodes of the last “Step” of each “LocationPath” in order to determine ex post facto whether that node is a solution for the “LocationPath” as a whole, for the period of time necessary to resolve the predicates or to verify the “AxisSpecifiers”, for example.

The present invention aims to mitigate these drawbacks.

To that end, according to a first aspect, the present invention is directed to a method of analyzing an XPath expression composed of sub-expressions to evaluate with respect to a structured document, that comprises:

a step of classifying the sub-expressions of said expression into a subset comprising calculation sub-expressions and a subset comprising navigation sub-expressions and

a step of linking each navigation sub-expression to the calculation sub-expression that uses it.

By virtue of these provisions, a representation of the XPath expressions is provided enabling the two limitations of the prior art to be overcome. In particular, the analyzing method of the present invention makes it possible to represent an XPath expression in a form adapted to be evaluated in a streaming environment. The analysis may be performed once and the evaluation may be performed several times on the analyzed expression without recourse to a new analysis. For example, an XSLT processor which defines a “stylesheet” comprising XPath expressions may, in a first compilation phase, launch the analysis of the XPath expressions then, in a second evaluation phase, launch the evaluation of those XPath expressions. It thus appears that, so long as the stylesheet has not been edited, the evaluation may be based on the analyzed XPath expressions, which reduces the processing time.

Another application of the analyzing method of the present invention concerns a parser of XPath expressions which gives an item of information on the compatibility of expressions with a streaming environment evaluation approach. This analysis, in an XSLT application context, also makes it possible to classify the expressions dependent on the XML document for their resolution separately from what are denoted static ones. This analyzer may thus form part of a compiler of XSLT, XQuery or any other language based on XPath, for the purpose of optimizing the processing of “stylesheets”.

The objective of the analysis is to isolate the parts of the expression necessitating XML information from the parts of the expression consisting of calculations or type conversions and thus to propose representations and mechanisms for evaluations enabling the former expressions to be resolved during the reading of the structured document.

According to particular features, the classifying step comprises a step of structuring each of the sub-sets of sub-expressions.

This structuring provides a re-usable representation of the expression and a basis for its evaluation.

According to particular features, during the structuring step, the subset comprising calculation sub-expressions are represented by an evaluation tree and the subset comprising navigation expressions are represented by a navigation tree.

By virtue of these provisions, the distribution of the results is simplified, compared with an approach representing the sub-expressions of navigation type and the sub-expressions of calculation type at the same time in a single structure made of targets.

According to particular features, during the structuring step, the navigation tree is constituted with compiled navigation targets, which structure makes it possible to represent the search for information corresponding to said expression in the structured document, each compiled navigation target being linked to a navigation sub-expression of “LocationPath” type and to at least one “Step” in that “LocationPath”.

This facilitates the distribution, the exploitation and the sending of the results coming from the structured document.

According to particular features, during the structuring step, each entity of “NodeTest” type of each “Step” is associated with at least one compiled navigation target.

This sharing of the NodeTests common to one or more compiled navigation targets makes it possible to reduce the number of tests to perform at the time of the evaluation. Furthermore, the representation of the expression is thereby more compact.

According to particular features, during the structuring step, it is determined whether a current compiled navigation target belongs to a new absolute or relative path, and, if yes, a new branch in the navigation tree is created.

By virtue of these provisions, the unique relationship between a navigation sub-expression and its expression of calculation type is ensured in the representation.

According to particular features, during the structuring step, it is determined whether the current compiled navigation target belongs to a new absolute or relative path and, if yes, a representation structure of a “LocationPath” is created as new leaf of the evaluation tree, this representation structure providing the link between the current branch of the evaluation tree and the new branch of the navigation tree.

This link enables the direct and automatic sending of a result arising from the structured document to the expression of calculation type that uses it.

According to particular features, the analyzing method of the present invention as succinctly set forth above comprises a step of creating an evaluation target associated with the current compiled navigation target, said evaluation target comprising information representing an evaluation status, a possible solution encountered during the evaluation and a link between the evaluation target and the current compiled navigation target.

According to particular features, in the case of a “LocationPath” of which at least one “Step” contains at least one predicate, the evaluation tree descends as far as the “Step” entity in order to link the sub-expression corresponding to the predicate to its parent sub-expression, the compiled target being inserted at the start of that new branch and a link of that compiled target to the “LocationPath” from which it comes is updated as well as a type associated with that compiled target indicating that it represents the first “Step” of the path.

According to particular features, during the classifying step, simplifications are made of the evaluation tree.

By virtue of these provisions, a representation is kept that is less costly in terms of memory occupancy than the tree prior to simplification.

For example; “ComparisonExpr” makes it possible to group together the high level calculation sub-expressions as a single node in the evaluation tree. Similarly, “PurePathExpr” makes it possible to “short-circuit” the different calculation sub-expressions when an XPath sub-expression has been identified as constituted solely of a navigation sub-expression. “PureFCall” also makes it possible to “short-circuit” the different calculation sub-expressions when an XPath sub-expression has been identified as constituted solely of a sub-expression corresponding to a “FunctionCall”. “ExprResuit” corresponds to the case in which a sub-expression is resolved as from compilation (“Literal” or “Number” case), in which case the evaluation tree is limited to a node which bears a result.

According to particular features, during the classifying step, a grammatical analysis step is carried out during which a semantic parser goes through the list of tokens of the expressions and identifies the types of expression defined by the syntax linked to the XPath language contained in the expression to analyze.

According to particular features, during the grammatical analysis step, for at least one token coming from a lexical analysis, determination is made, grammar rule by grammar rule, of whether the token satisfies said rule.

According to particular features, during the grammatical analysis step, if the token satisfies a rule, it is determined whether said rule is linked to a navigation sub-expression and, if yes, a navigation sub-expression is constructed and, otherwise, a calculation sub-expression is constructed.

According to particular features, during the classifying step, it is determined whether a sub-expression can contain other sub-expressions and, if yes, the representation of each said sub-expression comprises a reference to a parenthood link with at least one other sub-expression.

According to particular features, during the classifying step, a generic representation structure is implemented for different types of calculation sub-expressions.

This avoids a structure of representation by sub-expression as described in the grammar, so reducing the evaluation tree. Furthermore, this makes it possible to group together several sub-expressions into a single representation structure. For example, the sub-expressions of type “AndExpr”, “OrExpr”, “EqualityExpr”, “RelationalExpr”, “AdditiveExpr”, “MultiplicativeExpr”, and “UnaryExpr” may be represented by a generic sub-expression of “ComparisonExpr” type which consists of applying an operator to one or two operands.

The present invention is also directed to a method of evaluation relative to a structured document in markup language, that implements the expression analyzing method as succinctly set forth above and comprises a step of evaluating the expression implementing the evaluation of the navigation sub-expressions of the expression relative to data of the structured document.

Thus, the invention provides a means for evaluating XPath expressions in a streaming environment by an analysis of its expressions to distinguish the calculation part from the part dependent on XML data, while maintaining the link between those two parts for the purpose of the sending of results and while limiting their storage.

The advantages which may arise from these provisions include:

a high efficiency because the traversal of the XML document is a single traversal,

the sending of the results as soon as they are calculated,

the simple processing of the resulting XML nodes with a minimum storage,

the efficient evaluation due to the factorization of calculations such as the “NodeTests” and the resolution of the “AxisSpecifiers” in advance,

the evaluation is carried out without necessarily completely going through the XML document (control of the execution from the evaluation tree),

the analysis is re-usable, the internal representation calculated a single time may be evaluated several times relative to the same document or different documents and

the expression basis combines function calls or operations with purely navigational expressions.

According to particular features, during the step of evaluating the XPath expression, at least one calculation sub-expression and one navigation sub-expression are evaluated according to the following steps:
launching of the execution of the calculation sub-expressions by retrieving, from an evaluation tree representing the sub-set comprising calculation sub-expressions, what is denoted a “root” calculation expression and by going through what are denoted the “child” nodes until all the leaves of the evaluation tree have been reached.
going through the structured document to construct at least one result for each navigation sub-expression associated with a leaf calculation sub-expression of the evaluation tree,
sending each result of each navigation sub-expression to the associated calculation sub-expression,
   and, iteratively until the root calculation sub-expression of the evaluation tree is reached:
applying processing linked to the calculation sub-expression on the result,
in case the calculation sub-expression is a child node, propagating the result of said processing to the parent calculation sub-expression.

According to particular features, during the propagating step, if the parent calculation sub-expression has at least one calculation sub-expression not yet having undergone the step of applying processing, the iteration is suspended until each said child calculation sub-expression undergoes said step of applying processing.

According to a second aspect, the present invention is directed to a device for analyzing an XPath expression composed of sub-expressions to evaluate with respect to a structured document, that comprises:

a means for classifying the sub-expressions of said expression into a subset comprising calculation sub-expressions and a subset comprising navigation sub-expressions and

a means for linking each navigation sub-expression to the calculation sub-expression that uses it.

As the advantages, objectives and features of the device of the second aspect are similar to those of the method of the present invention, as succinctly set forth above, they are not reviewed here.

The present invention also concerns an analysis method and device as well as a method and device for evaluating an expression in relation to a structured document. It applies, in particular, to the evaluation of XPath requests in a streaming environment (XPath being the acronym for “XML Path Language” and XML being the acronym for “eXtensible Markup Language”).

The present invention is concerned, in particular, with processing expressions composed of both types of sub-expression, for example a function call of which at least one of the parameters is expressed by a “LocationPath”.

The document US 2005/0228768 concerns hybrid XPath expressions, that is to say containing at the same time navigation expressions and calculation expressions. It proposes a representation of the expressions in the form of trees in which a node may represent either a Step of a LocationPath, or a calculation to perform on the intermediate results. However, in this proposal, the evaluation is not made in a streaming environment. Each result of a node is always transmitted to its parent node. It is not possible to simplify the tree where there are several expressions to be evaluated.

The third to sixth aspects of the present invention aim to mitigate these drawbacks and, in particular, to provide a representation of the XPath expressions that is efficient, in particular in terms of result propagation.

To that end, according to a third aspect, the present invention is directed to a method of analyzing at least one expression composed of sub-expressions to evaluate with respect to a structured document, that comprises:

a step of identifying at least one navigation sub-expression of at least one expression to evaluate, at least one said navigation sub-expression comprising at least one location path step.

a step of representing each said location path step of each said navigation sub-expression, in compiled navigation target form, which is a structure representing the search for information corresponding to said location path step in the structured document.

and, for each location path step:

a step of determining a recipient for the result of an evaluation of said location path step and

a step of adding an item of identification information of said recipient, to the compiled navigation target of said location path step.

Identifying the navigation sub-expressions (typically the LocationPaths or location paths), makes it possible to determine the components of the expression which depend on the XML data. Extracting the location path steps (“steps”) from those navigation sub-expressions makes it possible to prepare the different tests to perform at the time of later evaluation. Identifying, for each location path step, a recipient for any result coming from that location path step, makes it possible to accelerate the transmission of the evaluation results and to avoid recourse to storage. Including that recipient in the representation of the location path step, i.e. the compiled navigation target, makes it possible to prepare the transmission of the evaluation results.

The implementation of the present invention makes it possible to provide all the tests to perform on performing a single traversal of the structured document.

According to particular features, during the step of determining a recipient, determination is made of a compiled navigation target that is recipient for the result of an evaluation of said location path step.

According to particular features, the method as succinctly set forth above comprises a step of organizing the compiled navigation targets according to their depth and a step of linking said compiled navigation targets to each other.

This makes it possible to plan the sequencing of the tests to perform during the evaluation.

According to particular features, during the linking step, branches of a navigation tree are constructed by the insertion of compiled navigation targets.

Evaluation in a streaming environment is thus enabled. The evaluation in a streaming environment consists firstly of processing the information of each document in a streaming environment and secondly of providing the application using the XPath processor with the results as soon as they have been calculated.

According to particular features, during the inserting step, the current compiled navigation target is inserted in the navigation tree that represents the current location path, according to the value of the axis of the current compiled navigation target.

According to particular features, during the representing step, both an instructions tree and a navigation tree are constructed.

This makes it possible to clearly separate the parts of the expressions that depend on structured data from the parts of the expressions that are purely calculational.

According to particular features, the method as succinctly set forth above comprises a step of determining redundant intermediate compiled navigation targets and a step of merging redundant intermediate compiled navigation targets.

The representation of the expression or expressions to evaluate is thus rendered more compact and the evaluation is thus rendered more efficient.

According to particular features, during the representing step, entry is made in a field of the compiled navigation target to state therein which location path said compiled navigation target belongs to.

According to particular features, each said expression is an XPath expression.

According to particular features, the representing step comprises:

a step of determining an axis value corresponding to the current location path step,

a step of identifying a node test which any node must satisfy that is a candidate for the resolution of the current location path step and

a step of identifying at least one predicate associated with the current location step.

According to particular features, the analysis method of the present invention, as succinctly set forth above, comprises a step of grouping together compiled navigation targets on the basis of node tests associated with said compiled navigation targets.

The cost in terms of memory of the representation of the compiled expressions is thus reduced.

According to particular features, during the step of grouping together, for at least two compiled navigation targets corresponding to the same level of depth, it is determined whether the node tests have the same value and, if yes, one of the targets is updated with the values of child compiled navigation target links and any predicates, of the other compiled navigation target.

According to particular features, if at least one predicate is identified, a link to the first compiled navigation target of each predicate is kept at the level of the current compiled navigation target.

According to particular features, if at least one predicate is identified, the current compiled navigation target maintains a link to each sub-expression which corresponds to said predicate.

This makes it possible to determine, during the evaluation, whether its predicates are resolved or not.

According to particular features, to determine said recipient, it is determined whether there is a parent compiled navigation target and, if yes, it is determined whether that parent compiled navigation target contains at least one predicate and, if that parent compiled navigation target contains no predicate, the recipient for the results of the parent compiled navigation target becomes the recipient for the results of the current compiled navigation target.

This makes it possible to link the last compiled navigation target producing a result to the compiled navigation target that is the closest possible to the root of the navigation tree in order to accelerate the passing up of the results.

According to particular features, to determine said recipient, it is determined whether there is a parent compiled navigation target and, if yes, it is determined whether that parent compiled navigation target contains at least one predicate and, if yes, the parent compiled navigation target becomes the recipient for the results of the evaluation of the current compiled navigation target.

This makes it possible, when the evaluation results pass up, not to consider compiled navigation targets on which no processing of that result is to be carried out.

According to a fourth aspect, the present invention concerns a method of evaluating at least one expression composed of sub-expressions to evaluate with respect to a structured document, that comprises the steps of the analysis method of the third aspect of the present invention, as succinctly set forth above and a step of evaluating each said expression using at least one said compiled navigation target incorporating an identification of the evaluation result recipient for a location path step of a navigation sub-expression of a said expression.

According to particular features, during the evaluating step, an evaluation is carried out in a streaming environment.

According to particular features, the evaluating method as succinctly set forth above comprises a step of generating evaluation targets, with a compiled navigation target corresponding to at least one evaluation target which bears the information relative to the status of the execution.

This distinction between compiled navigation targets and evaluation targets makes it possible to keep the navigation tree intact for the purpose of evaluations that are multiple or in parallel, possibly on different documents.

According to particular features, during the evaluating step, a node test is retrieved depending on the content of a compiled navigation target associated with the current evaluation target and furthermore a node is retrieved and it is determined whether said node satisfies said node test.

This makes it possible to determine whether an evaluation target has been reached or not.

According to particular features, during the evaluating step, if an evaluation target is resolved and if said evaluation target is a leaf of a navigation tree, the current node is propagated to the recipient associated with the current evaluation target.

According to particular features, during the evaluating step, if a recipient evaluation target, other than the root of a navigation tree, receives a solution XML node, the latter is used for the resolution of said evaluation target and, if that XML node enables a result to be obtained for that evaluation target, that result is sent to the recipient target associated with the current evaluation target.

According to a fifth aspect, the present invention is directed to a device for analyzing at least one expression composed of sub-expressions to evaluate with respect to a structured document, that comprises:

a means for identifying at least one navigation sub-expression of at least one expression to evaluate, at least one said navigation sub-expression comprising at least one location path step,

a means for representing each said location path step of each said navigation sub-expression, in the form of a compiled navigation target,

a means for determining a recipient for the result of an evaluation of each location path step and

a means for adding an item of identification information of said recipient, to the compiled navigation target of said location path step.

According to a sixth aspect, the present invention concerns a device for evaluating at least one expression composed of sub-expressions to evaluate with respect to a structured document, that comprises an analyzing device of the fifth aspect of the present invention, as succinctly set forth above and a means for evaluating each said expression using at least one of said compiled navigation targets incorporating an identification of the evaluation result recipient for a location path step of a navigation sub-expression of a said expression.

According to a seventh aspect, the present invention concerns a computer program loadable into a computer system, said program containing instructions enabling the implementation of the method of the present invention as succinctly set forth above.

According to a eighth aspect, the present invention concerns an information carrier readable by a computer or a microprocessor, removable or not, storing instructions of a computer program, that enables the implementation of the method of the present invention as succinctly set forth above.

As the advantages, objectives and features of the method, devices, computer program and information carrier are similar to those of the method of the third aspect of the present invention, as succinctly set forth above, they are not reviewed here.

The different aspects of the present invention are intended to be implemented together, in particular embodiments of the present invention.

Other advantages, objectives and features of the present invention will emerge from the following description, given, with an explanatory purpose that is in no way limiting, with respect to the accompanying drawings, in which:

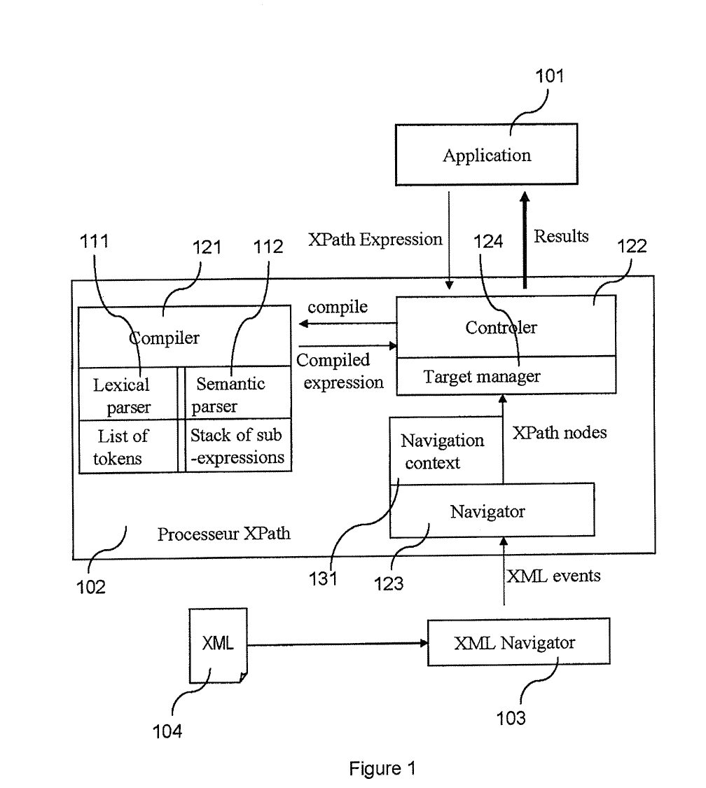

FIG. 1 is a diagram of the application context of a particular embodiment of the first and second aspects of the present invention,

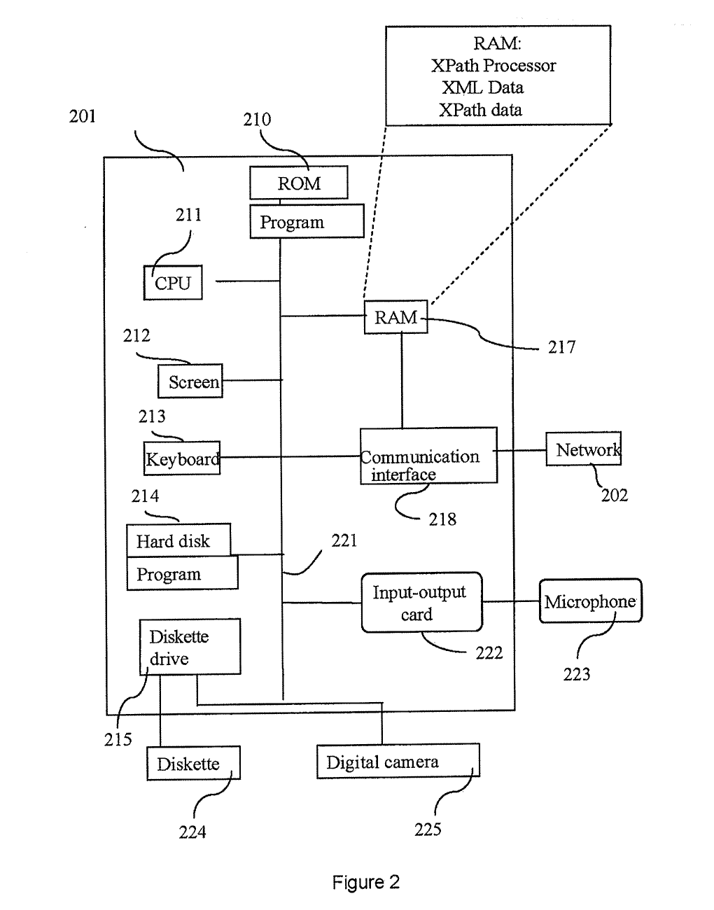

FIG. 2 is a diagram of a particular embodiment of the device of the second aspect of the present invention,

FIG. 3 represents an XML document and expressions,

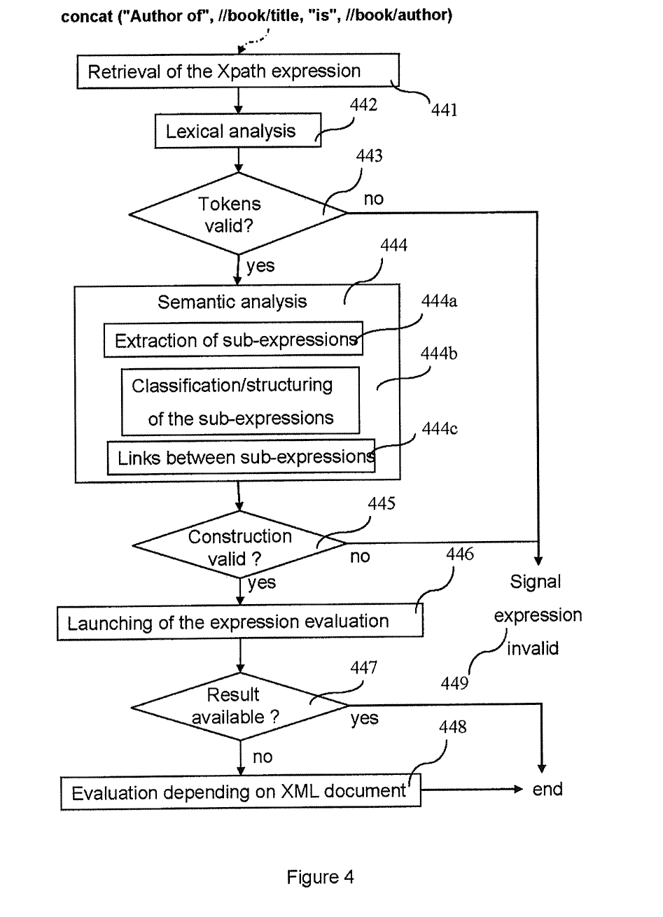

FIGS. 4 to 7 are logigram representations of the steps implemented in a particular embodiment of the method of the first aspect of the present invention,

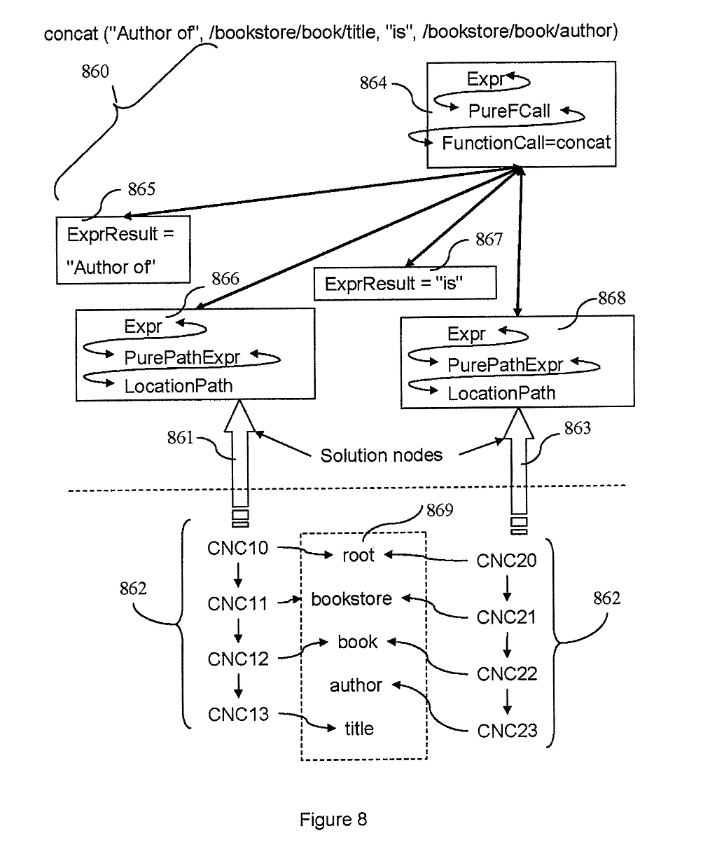

FIGS. 8 to 10 are diagrams an evaluation tree implemented in particular embodiments of the first and second aspects of the present invention,

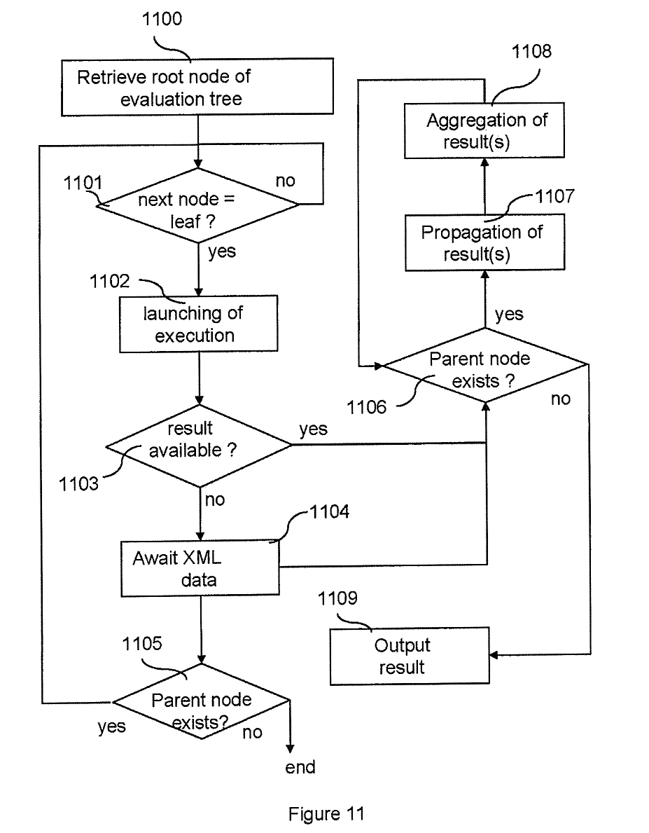

FIGS. 11 to 15 are logigram representations of the steps implemented in a particular embodiment of the method of the first aspect of the present invention.

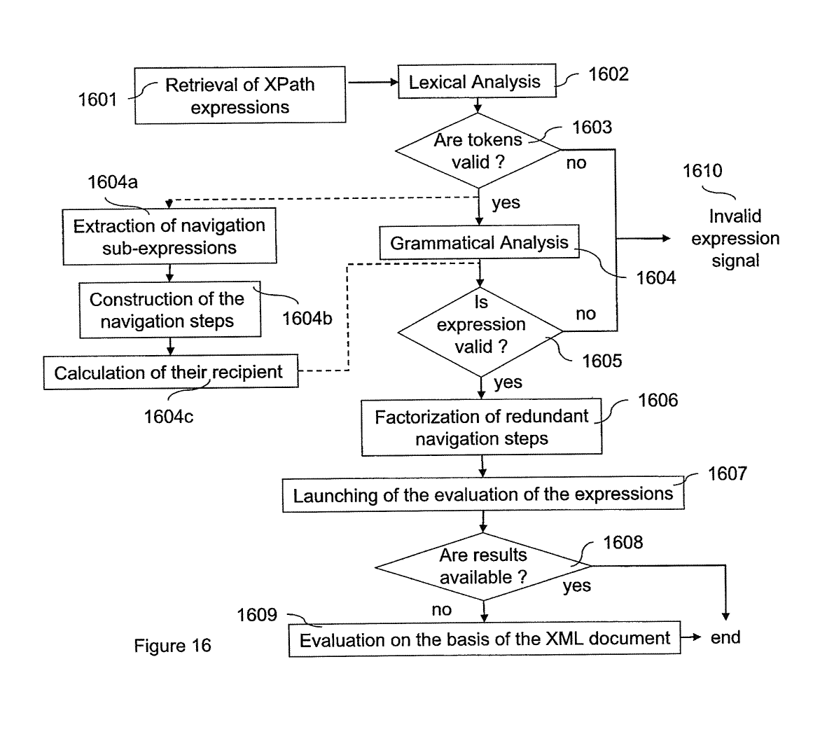

FIG. 16 represents, in logigram form, the main steps of a particular embodiment of the method of the third and fourth aspects of the present invention,

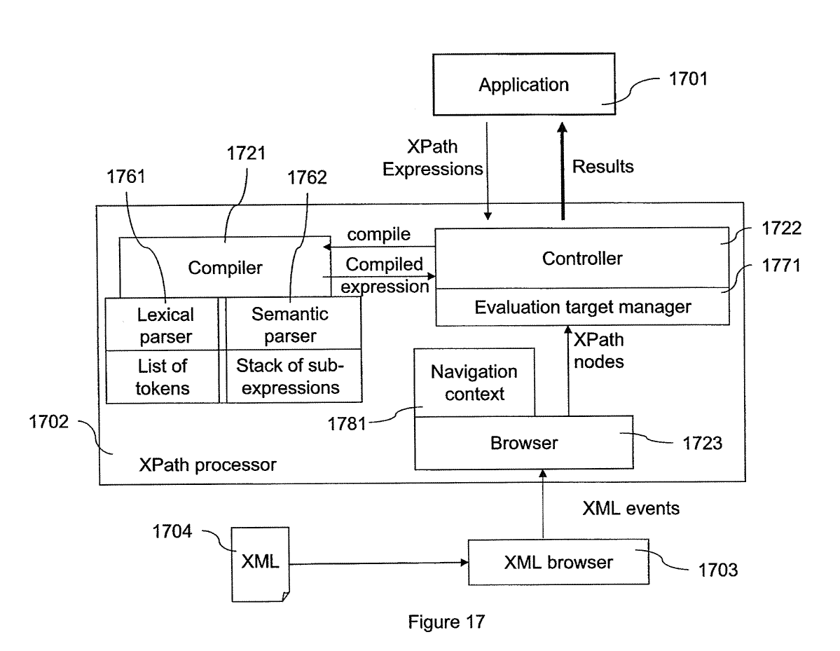

FIG. 17 is a diagram of a particular embodiment of the device of the fifth and sixth aspects of the present invention,

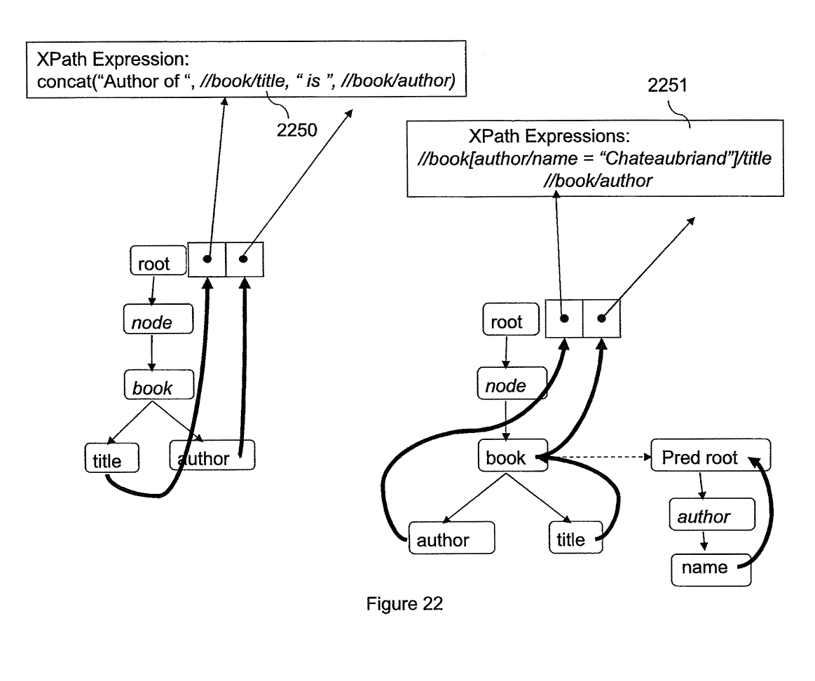

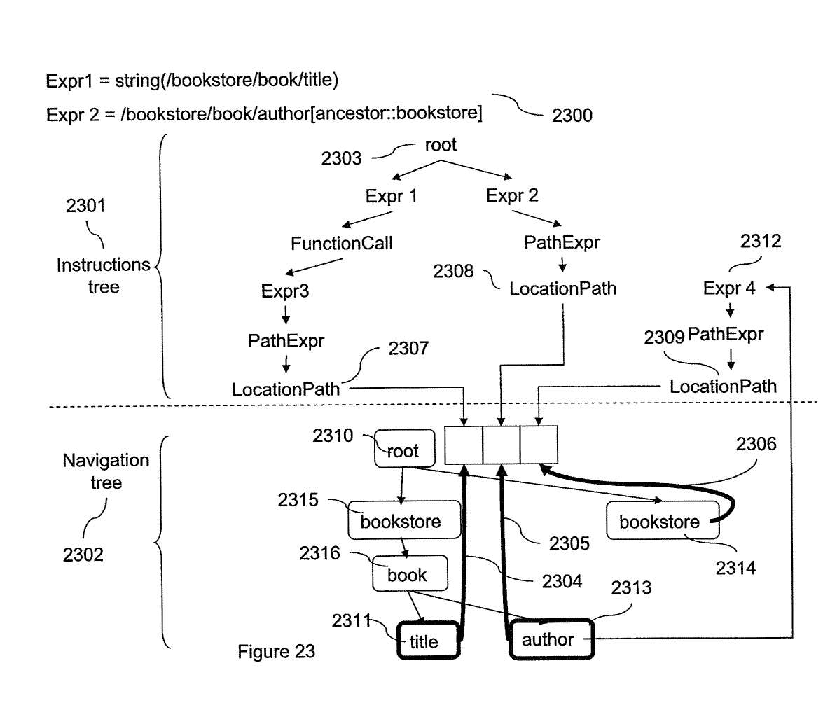

FIGS. 22 and 23 illustrate relationships between elements of an expression and

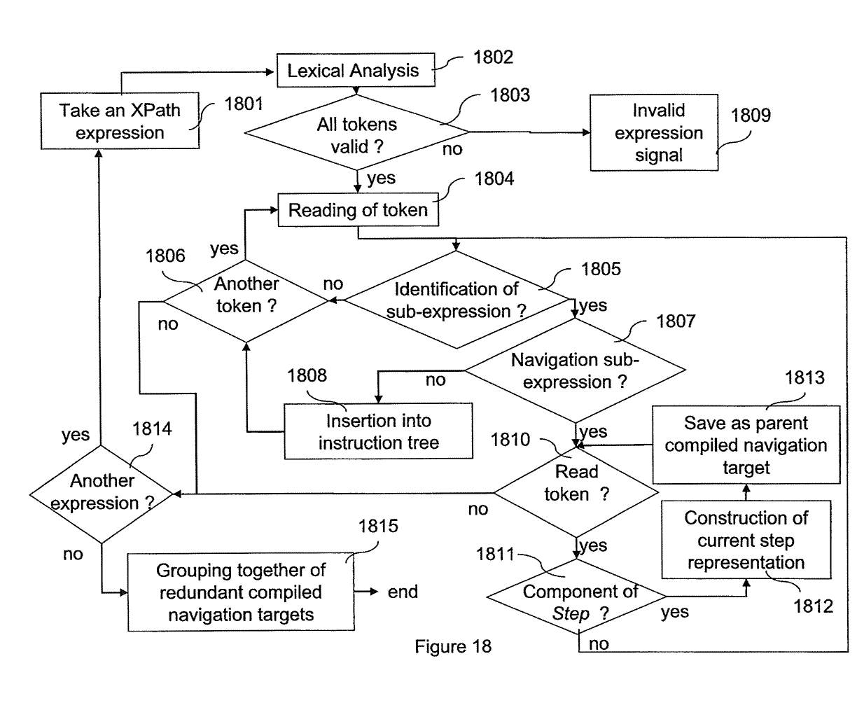

FIGS. 18 to 21 and 24 to 29 are logigram representations of the steps implemented in a particular embodiment of the method of the third and fourth aspects of present invention.

FIG. 1 describes the application context of the present invention. The typical scenario for use of the present invention involves an application 101 manipulating XML/data extracted by one or more XPath processors 102 by virtue of one or more XML parsers (or navigators) 103 working on an XML data stream 104. The XPath processor comprises the following main entities:

a compiler 121 which analyzes the expressions and translates them into an internal representation, described with reference to FIG. 4. This is composed of two parsers, one 111 being lexical, and the other 112 semantic.

an execution control unit 122 which manages the communication with the application, the interactions between the different modules and takes on the task of evaluating the nodes. It is composed in particular of an entity 124 responsible for the resolution of the steps composing the navigation sub-expressions, termed “target manager” and

a navigator 123 which enables the execution control unit to communicate generically with any XML parser 103 and to represent and store the XML events in the form of XPath nodes in a navigation context 131

The main steps of the evaluation of an XPath expression are its analysis for it to be compiled, and then its evaluation. The implementation of the present invention is carried out by the XPath processor or processors 102.

FIG. 2 illustrates a particular embodiment of the device of the present invention. This device 201, for example a micro-computer and its various peripherals, comprises a communication interface 218 connected to a communication network 202 adapted to send and receive digital data. The device 201 also comprises a storage means 214 such as a hard disk. It also comprises a diskette drive 215. The diskette 224 may contain XML data to process as well as the code of a program implementing the present invention, which, once read by the device 201, is stored on the hard disk 214. According to a variant, the program enabling the device to implement the present invention is stored in read only memory (ROM) 210. In a second variant, the program can be received in order to be stored in an identical manner to that described previously via the communication network 202.

The device 201 possesses a screen 212 making it possible to view the results of the evaluations. Using the keyboard 213, the user may specify an XPath expression. The central processing unit 211 (“CPU” in the drawing) executes the instructions relating to the implementation of the invention, which are stored in the read only memory 210 or in the other storage means. On powering up, the programs relative to the evaluation of XPath expressions and for extraction of the XML events that are stored in a non-volatile memory, for example the ROM 210, are transferred into the random access memory RAM 217, which then contains the executable code of the invention, as well as registers for storing the variables necessary for implementing the invention. Naturally, the diskettes 224 may be replaced by any type of information carrier such as a compact disc or a memory card. More generally, an information storage means, which can be read by a computer or by a microprocessor, integrated or not into the device, and which may possibly be removable, stores a program implementing the method of the present invention. The communication bus 221 enables communication between the different elements included in the microcomputer 201 or connected to it. The representation of the bus 221 is non-limiting and, in particular, the central processing unit 211 is able to communicate instructions to any element of the microcomputer 201 directly or by means of another element of the microcomputer 201.

The particular embodiment of the method of the present invention described with reference to FIGS. 4 to 15 consists, via an analysis of the XPath expression to evaluate, of classifying the sub-expressions of that expression into two sub-sets of sub-expressions: one subset of the calculation type expressions (referred to in the following portion of the description as “calculation expressions”) and a subset of the navigation type expressions (referred to in the following portion of the description as “navigation expressions”). Next, for each subset of sub-expressions, an adapted representation structure is created. An evaluation tree represents the subset of calculation type sub-expressions whereas a navigation tree represents the subset of the navigation type sub-expressions. Furthermore, each navigation sub-expression is linked to the calculation type sub-expression which it uses, in order to facilitate the propagation and the calculation of the results. Lastly, the nodes of the navigation tree serve as a basis for the evaluation of the navigation sub-expressions relative to XML data received by streaming.

FIG. 4 illustrates steps implemented on the evaluation of an XPath expression. The XPath expression to evaluate may, without this being limited, be specified by a user or be pre-stored in a file read by the application or else derive from the execution at the application level of a program generating XPath requests. The expression is received by the XPath processor 102 at step 441. Next, during the step 442, the characters which represent XPath expression are analyzed one by one, and are grouped into tokens. These tokens may represent reserved tokens, suitable for specification, such as the character “/”, or the token “::” . . . or simple characters or digits (portmanteau word from “digital units”). Step 442 is carried out by the lexical parser 111, which possesses a table of predefined tokens according to the XPath 1.0 grammar.

Further to the decomposition into tokens carried out during step 442, the tokens generated are tested during a step 443. If during this step 443, one of the tokens is analyzed as not permitted or unknown by the lexical parser 111, the compiler 121 stops the processing and informs the XPath processor 102 of the non-compliance of the expression, at a step 449. The expression cannot thus be evaluated. In a variant, the unrecognized token is ignored and the compilation is continued.

If the lexical parser 111 determines, during the step 443, that all the tokens considered are valid, a grammatical analysis step 444 is proceeded to. This step 444 consists, for the semantic parser 112, of going through the list of tokens coming from step 442 and of identifying the types of expression defined by the XPath 1.0 syntax (see table below) and contained in the expression to compile.

The right hand column of this table identifies the levels introduced by the invention in order to compact the evaluation tree,

| | Type of | | | |
|---|---|---|---|---|
| | expression | | | |
| Type of | or sub- | | | Simplified |
| result | expression | | Rule of construction | type |
| Not | Expr | := | OrExpr | |
| determined | | | | |
| Boolean | OrExpr | := | AndExpr \| | Compariso$$ |
| | | | OrExpr ‘or’ AndExpr | Expr |
| Boolean | AndExpr | := | EqualityExpr \| | |
| | | | AndExpr ‘and’ EqualityExpr | |
| Boolean | EqualityExpr | := | RelationalExpr \| | |
| | | | EqualityExpr ‘=’ | |
| | | | RelationalExpr \| | |
| | | | EqualityExpr ‘!=’ | |
| | | | RelationalExpr | |
| Boolean | RelationalExpr | := | AdditiveExpr \| | |
| | | | RelationalExpr ‘<’ | |
| | | | AdditiveExpr \| | |
| | | | RelationalExpr ‘>’ | |
| | | | AdditiveExpr \| | |
| | | | RelationalExpr ‘<=’ | |
| | | | AdditiveExpr \| | |
| | | | RelationalExpr ‘>=’ | |
| | | | AdditiveExpr | |
| Number | AdditiveExpr | := | MultiplicativeExpr \| | |
| | | | AdditiveExpr ‘+’ | |
| | | | MultiplicativeExpr \| | |
| | | | AdditiveExpr ‘−’ | |
| | | | MultiplicativeExpr | |
| Number | Multiplicative | := | UnaryExpr \| | |
| | Expr | | MultiplicativeExpr | |
| | | | MultiplyOperator | |
| | | | UnaryExpr \| | |
| | | | MultiplicativeExpr ‘div’ | |
| | | | UnaryExpr \| | |
| | | | MultiplicativeExpr ‘mod’ | |
| | | | UnaryExpr | |
| Not | UnaryExpr | := | UnionExpr \| ‘-’ UnaryExpr | |
| determined | | | | |
| Not | UnionExpr | := | PathExpr \| | |
| determined | | | UnionExpr ‘\|’ PathExpr | |
| Not | PathExpr | := | LocationPath \| | PurePathExpr |
| determined | | | FilterExpr \| | |
| | | | FilterExpr ‘/’ | |
| | | | RelativeLocationPath \| | |
| | | | FilterExpr ‘//’ | |
| | | | RelativeLocationPath | |
| Not | FilterExpr | := | PrimaryExpr \| FilterExpr | |
| determined | | | Predicate | |
| Not | PrimaryExpr | := | VariableReference \| | ExprResult |
| determined | | | ‘(‘ Expr ’)’ \| | PureFCall |
| string | | | Literal \| | |
| number | | | Number \| | |
| cf. | | | FunctionCall | |
| specification | | | | |
| nodes | LocationPath | := | RelativeLocationPath \| | |
| | | | AbsoluteLocationPath \| | |
| nodes | AbsoluteLocation | := | ‘/’ RelativeLocationPath? \| | |
| | Path | | AbbreviatedAbsoluteLocation | |
| | | | Path | |
| nodes | RelativeLocation | := | Step \| | |
| | Path | | RelativeLocationPath ‘/’ | |
| | | | Step \| | |
| | | | AbbreviatedRelativeLocation | |
| | | | Path | |
| nodes | AbbreviatedAbsolute | := | ‘//’RelativeLocationPath | |
| | Location | | | |
| | Path | | | |
| nodes | AbbreviatedRelative | := | RelativeLocationPath ‘//’ | |
| | Location | | Step | |
| | Path | | | |
| nodes | Step | := | AxisSpecifier NodeTest | |
| | | | Predicate* \| | |
| | | | AbbreviatedStep | |
| nodes | AbbreviatedStep | := | ‘.’ \| | |
| | | | ‘..’ | |
| nodes | AxisSpecifier | := | AxisName ‘::’ \| | |
| | | | AbbreviatedAxisSpecifier | |
| nodes | AbbreviatedAxis | := | ‘@’? | |
| | Specifier | | | |
| Boolean | NodeTest | := | NameTest \| | |
| | | | NodeType ‘(‘ ’)’ \| | |
| | | | ‘processing-instruction’ ‘(‘ | |
| | | | Literal ’)’ | |
| Boolean | NameTest | := | ‘*’ \| NCName ‘:’ ‘*’ \| QName | |
| Boolean | NodeTest | := | ‘comment’ \| ‘text’ \| | |
| | | | ‘processing-instruction’ \| | |
| | | | ‘node’ | |
| Boolean | Predicate | := | ‘[‘ PredicateExpr ’]’ | |
| Boolean | PredicateExpr | := | Expr | |
| cf. | FunctionCall | := | FunctionName ‘(‘ | |
| specification | | | (Argument ( ‘,’ Argument)* | |
| | | | )? ’)’ | |
| Not | Argument | := | Expr | |
| determined | | | | |

It is to be noted that the sub-expressions classified as sub-expressions or components of navigation expressions are the following:

| | | | | |
|---|---|---|---|---|
| Not | | := | LocationPath \| | PurePath |
| determined | | | RelativeLocationPath \| | Expr |
| | | | RelativeLocationPath | PureFCall |
| nodes | LocationPath | := | RelativeLocationPath \| | |
| | | | AbsoluteLocationPath \| | |
| nodes | AbsoluteLocation | := | ‘/’ RelativeLocationPath? \| | |
| | Path | | AbbreviatedAbsoluteLocation | |
| | | | Path | |
| nodes | RelativeLocation | := | Step \| | |
| | Path | | RelativeLocationPath ‘/’ Step \| | |
| | | | AbbreviatedRelativeLocation | |
| | | | Path | |
| nodes | AbbreviatedAbsolute | := | ‘//’RelativeLocationPath | |
| | Location | | | |
| | Path | | | |
| nodes | AbbreviatedRelative | := | RelativeLocationPath ‘//’ Step | |
| | Location | | | |
| | Path | | | |
| nodes | Step | := | AxisSpecifier NodeTest | |
| | | | Predicate* \| | |
| | | | AbbreviatedStep | |
| nodes | AbbreviatedStep | := | | |
| nodes | AxisSpecifier | := | AxisName ‘::’ \| | |
| | | | AbbreviatedAxisSpecifier | |
| nodes | AbbreviatedAxis | := | | |
| | Specifier | | | |
| Boolean | NodeTest | := | NameTest \| | |
| | | | NodeType ‘(‘ ’)’ \| | |
| Boolean | NameTest | := | | |
| Boolean | NodeTest | := | | |
| Boolean | Predicate | := | | |
| Boolean | PredicateExpr | := | | |

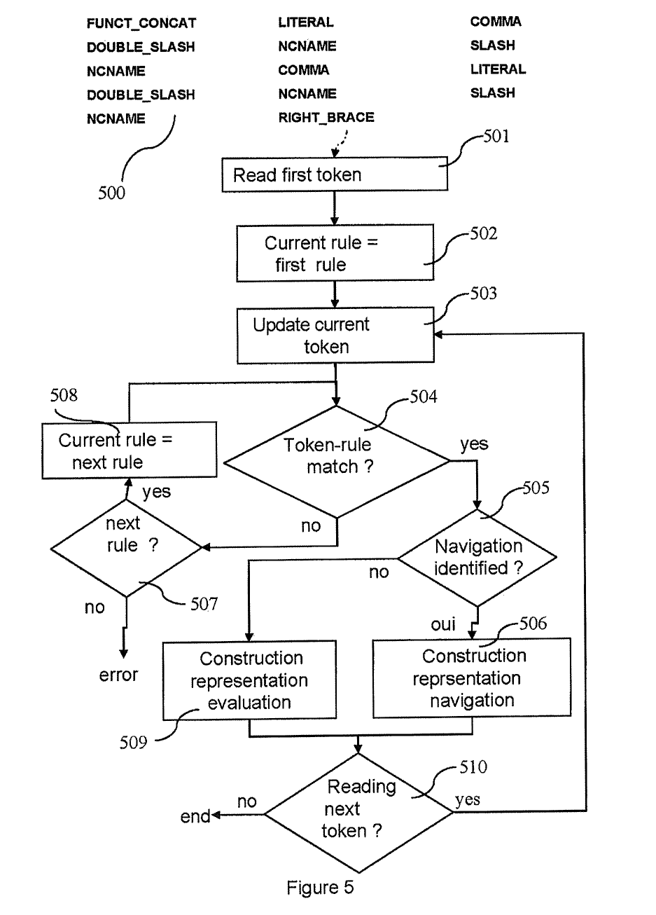

It is also during this step 444, detailed relative to FIG. 5, that the expression is analyzed (step 444a) in order to classify the sub-expressions (step 444b) that compose it, as set forth relative to FIG. 5. For example, if the first token found corresponds to “/”, it is an “AbsoluteLocationPath” according to the XPath grammar. In this case, the compiler 121 continues the analysis of the tokens to identify the components of that “AbsoluteLocationPath”, typically “Steps”, themselves composed of “AxisSpecifier”, “NodeTest” and possibly, “Predicates”. A step 444c next makes it possible to link each navigation sub-expression to the calculation type sub-expression that uses it.

During a step 445, it is determined whether the series of tokens enables a valid expression to be constructed according to the XPath grammar. If yes, the expression has been compiled with success and, during a step 446, the evaluation is launched. In the opposite case, an error signal is output by the compiler 121, during a step 449, in order to inform the XPath processor that the expression cannot be evaluated. The course of step 446 is described with reference to FIG. 11. Then, during a step 447, it is determined whether a result is available. If yes, the evaluation of the expression is finished. Otherwise, the evaluation continues depending on XML data, at a step 448 described with reference to FIG. 11.

FIG. 5 illustrates steps of a semantic analysis of an XPath expression, which details step 444 of FIG. 4. These steps are directed to:

identifying the sub-expressions of calculation type in the XPath expression to evaluate,

identifying the sub-expressions of navigation type in the XPath expression to evaluate,

structuring the subset of the calculation sub-expressions, for example by constructing an evaluation tree representing the set of the calculation sub-expressions,

structuring the subset of the navigation sub-expressions, for example by constructing a navigation tree representing the set of the navigation sub-expressions,

linking each branch of the navigation tree to a leaf of the evaluation tree and

initializing an evaluation tree of the set of the navigation sub-expressions.

An example of representation according to such steps is given in FIG. 8: the evaluation tree 860 is linked to the navigation tree 862 by links 861 and 863. The evaluation tree 860 is composed of a function call 864 comprising four parameters 865 to 868. The XPath grammar indicates that a function call (“FunctionCall”) may accept zero, one, or several parameters, these parameters being any type of XPath expression (“Expr”). In the example provided, the function called is the function “concat” which makes it possible to concatenate strings. This function may accept a number of parameters greater than or equal to 2. In the example, it contains 4 parameters represented by expressions of different types. As these expressions are a component of another expression, they are designated as sub-expressions. The navigation tree 862 is composed of “compiled navigation targets” (CNCij) in which i is linked to a sub-expression of LocationPath type and j is the index of the “Step” in that “LocationPath”. The different trees constructed by the semantic parser 112 are so constructed according to a bottom-up approach, as is known by the person skilled in the art, for example from “Compilateurs: Principes, techniques et outils” by Alfred Aho, Ravi Sehti and Jeffrey Ullman, Editions Dunod, 2000: the leaves of the evaluation tree are constructed first then grouped together when going through the tokens coming from the lexical analysis 442.

The implementation of these different steps in the semantic parser is now detailed with reference to FIG. 5. This parser possesses the list of tokens 500 that were constructed by the lexical parser 111 during step 442 and validated during step 443 as well as the XPath grammar detailed in the first table above. During a step 501, the semantic analyzer 112 retrieves the first token from the list 500. Next, during a step 502, the current rule to consider by the semantic parser is initialized to the first rule of the XPath grammar (in the first table above, this is an item of the second column). The current token is also initialized, during a step 503, with the value of the first token read at step 501.

During a step 504, the semantic analyzer 112 determines whether the current token satisfies a construction rule (or rules) of the current rule. For example, if the first token corresponds to “//”, the first rule identified will be the construction rule associated with an “AbbreviatedLocationPath”.

If that is not the case, the semantic parser 112 determines, during a step 507, whether there remain rules to consider and, if yes, it considers the following rule in the grammar as current rule, during a step 508. To that end, the semantic parser 112 maintains a stack of the sub-expressions encountered which correspond to the types of rules traversed, the sub-expression at the top of the stack being the last read.

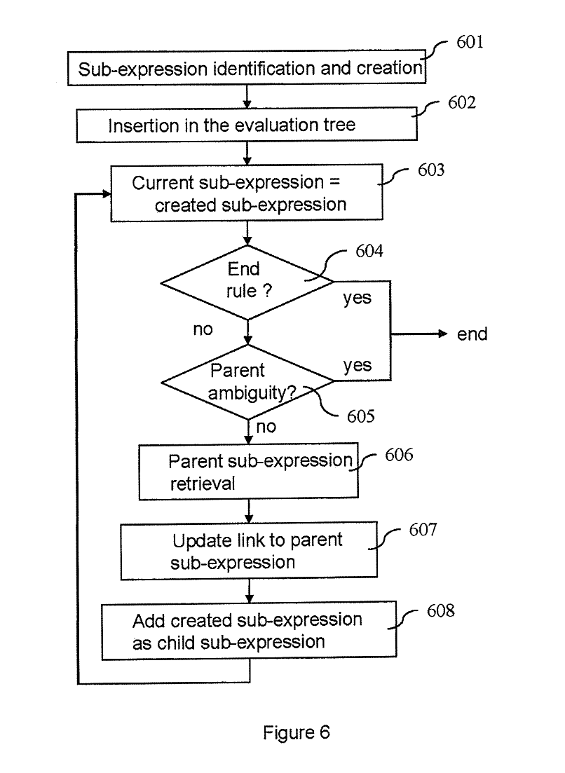

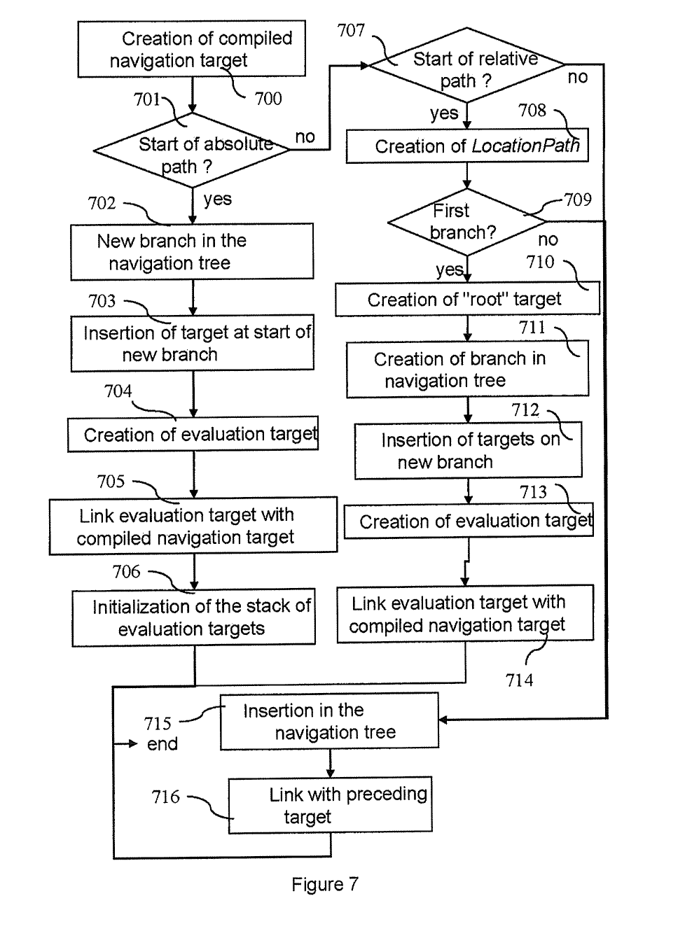

If, during the step 504, the semantic parser 112 determines that the current token is involved in one of the constructions associated with the current rule, the analyzer determines whether that current rule is linked to a navigation sub-expression, at a step 505. If yes, the semantic parser 112 carries out a step 506 of constructing a navigation sub-expression, as described with reference to FIG. 7. Otherwise, the semantic parser 112 passes on to the construction of a calculation sub-expression, as set forth with reference to FIG. 6, during a step 509. When all the rules have been gone through, that is to say when the result of the test step 507 is negative, without it being possible for the current token to be matched with the rule, an error is detected, which leads to a invalid expression at the step 445. Further to steps 506 or 509 of constructing sub-expressions, of navigation or calculation type respectively, the semantic parser 112 determines whether there remains a token to analyze, during a step 510, and, if yes, passes to the following token and returns to step 503. If no token remains to analyze, the construction of sub-expressions is finished.

FIG. 6 illustrates the processing of a calculation expression, during the step 509. It is thus considered here that the current rule identified during the step 504, to which the current token corresponds, corresponds to a construction rule which is not relative to navigation sub-expressions, the result of test 505 being negative, that is to say that it is not present in the second table above. In this case, a representation of the sub-expression associated with that rule is created. With each type of calculation sub-expression defined by the XPath grammar there is associated a representation structure which comprises at least:

the type of the sub-expression,

an evaluation status (“to launch”, “in course of processing” or “terminated”),

a possible link to a parent sub-expression,

links to the sub-expression or sub-expressions which compose it,

a series of instructions necessary for its evaluation and

a series of instructions necessary for the processing and for the propagation of a result.

Step 509, detailed in FIG. 6, consists, for the semantic parser 112, of constructing a structure of this type. During a step 601, the sub-expression is identified that is associated with the construction rule identified in step 504 and a representation structure is created as described above. At a step 602, the sub-expression so created is inserted in the evaluation tree as a leaf of the tree. It becomes the current sub-expression for the semantic parser 112 at a step 603. The semantic parser 112 then determines whether it is a terminal rule, at a step 604, by determining whether the current sub-expression may itself contain other sub-expressions (for example a “FunctionCall” with Arguments) or not (for example a “FunctionCall” without Arguments or a “VariableReference”). If yes, the construction step 509 is finished. If not, the semantic parser 112 determines, for the current sub-expression, whether there is ambiguity as to the parent sub-expression or not, during a step 605. If there is such ambiguity, step 509 ends. If there is no ambiguity, for example a “FunctionCall” can only arise from a “PrimaryExpr” which can itself only arise from a “FilterExpr”, during a step 606, the semantic parser 112 retrieves the parent sub-expression from its stack and withdraws it from the stack. The semantic analyzer 112 creates a representation for this parent sub-expression during the step 606. Next, during a step 607, a parenthood link is created from the current sub-expression to the parent sub-expression. Similarly, the filiation link from the representation of the parent sub-expression is initialized towards the representation of the current sub-expression, during a step 608. It is noted that these steps 607 and 608 amount to the insertion of the parent sub-expression created as parent node of the current sub-expression, into the evaluation tree. Next, step 603 is returned to during which the last sub-expression created becomes the current sub-expression until all the sub-expressions of the stack of sub-expressions of the semantic parser 112 have been unstacked.

According to a preferred embodiment, the semantic parser 112 uses a generic representation structure for different types of calculation sub-expressions. This avoids a structure of representation by sub-expression as described in the grammar, so reducing the evaluation tree. Furthermore, this makes it possible to group together several sub-expressions into a single representation structure. For example the sub-expressions of type “AndExpr”, “OrExpr”, “EqualityExpr”, “RelationalExpr”, “AdditiveExpr”, “MultiplicativeExpr”, and “UnaryExpr” may be represented by a generic sub-expression of “ComparisonExpr” type which consists of applying an operator to one or two operands. In this preferred embodiment, the semantic parser 112 makes reference to the right column of the grammar (“Simplified type”) described in the first table above. This column shows the possible simplifications on the evaluation tree:

“ComparisonExpr” makes it possible to group together the high level calculation sub-expressions as a single node in the evaluation tree,

“PurePathExpr” makes it possible to “short-circuit” the different calculation sub-expressions when the semantic parser 112 identifies an XPath sub-expression as constituted solely of a navigation sub-expression,

“PureFCall” also makes it possible to short-circuit the different calculation sub-expressions when the semantic parser 112 identifies an XPath sub-expression as constituted solely of a sub-expression corresponding to a “FunctionCall” and

“ExprResult” corresponds to the case in which a sub-expression is resolved as from compilation (“Literal” and “Number” cases). In this particular case, the evaluation tree is limited to a node which bears one result.

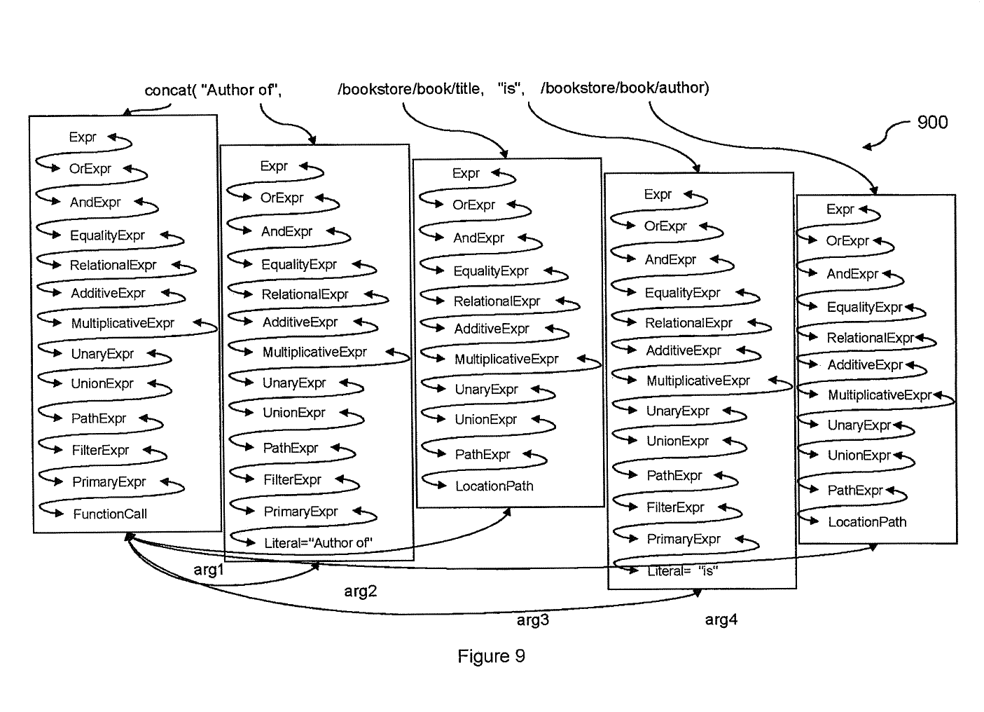

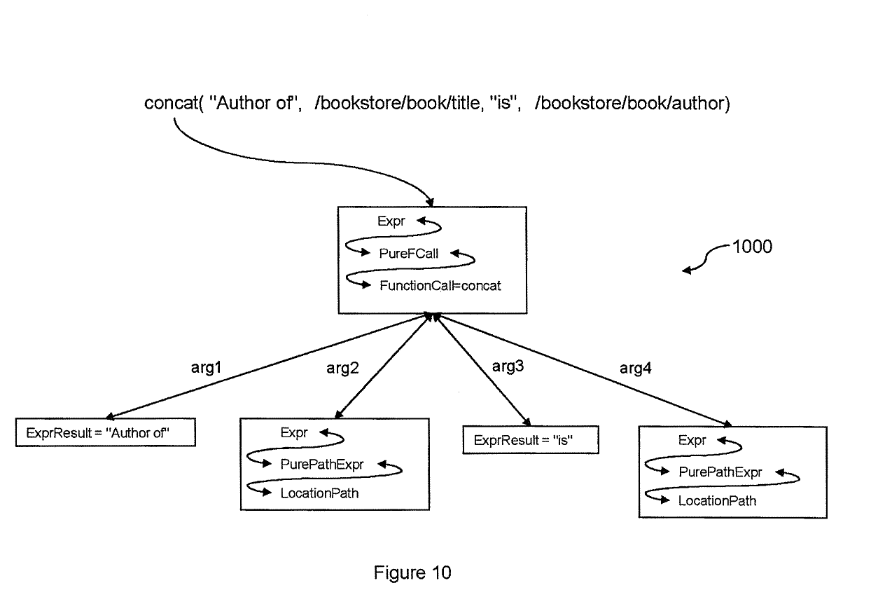

FIG. 9 illustrates a evaluation tree considering all the sub-expressions of the grammar. Its simplification according to the rules set forth above leads to the evaluation tree of FIG. 10. It clearly appears that the number of levels to go through, both for the launching of the execution and for the sending up and processing of the results, is appreciably reduced by these simplifications.

As regards the navigation expressions, the construction of their representation is detailed with reference to FIG. 7. It is considered here that the current construction rule identified during the step 504 as corresponding to the current token, corresponds to construction rule relative to a navigation sub-expression. This may be the case for example for a token “/”, “.”, “..” or “//” or any other token making it possible to identify the start of a navigation sub-expression (essentially a “Step” and the sub-expressions of the second table given above). In this case, at step 506, the semantic parser 112 signals to the execution controller that there will be a new navigation sub-expression to evaluate. During this step, the semantic parser 112 prepares or updates the navigation tree in the following manner. During a step 700, the semantic analyzer 112 creates a compiled navigation target, which structure makes it possible to represent the search for XML information associated with a “Step”. The compiled navigation target contains at least:

a link to the “LocationPath” from which it comes,

a type indicating whether the target concerns a predicate or not and whether or not it is the first in its “LocationPath”,

a link to the target corresponding the following “Step” in the “LocationPath”,

an item of information on the “AxisSpecifier” of the “Step” that it represents and

an item of information on the “NodeTest” to verify for the “Step” that it represents; and

possibly, a list of predicates associated with the “Step” that it represents.

Concerning the item of information on the “NodeTest”, this entity is present in each expression of “Step” type. As soon as a “Step” is identified, during the step 505, its associated “NodeTest” is extracted by the semantic parser 112. The semantic parser 112 determines, in a “NodeTest” stack, as illustrated at 869 in FIG. 8, whether the last “NodeTest” encountered is already present or not. If it is already present, the item of information on the “NodeTest” of the target in course of construction is linked to that “NodeTest”. Otherwise, the last “NodeTest” encountered is inserted in the “NodeTest” stack 869 and the item of information on the “NodeTest” of the target in course of construction is linked to the latter. This enables several compiled navigation targets to correspond to the same “NodeTest”.

Next, during a step 701, it is determined whether the navigation target belongs to a new absolute path (“AbsoluteLocationPath”), which amounts to testing whether the current token is equal to “/” or to “//”. If this is the case, during a step 702, the semantic parser 112 creates a new branch in the navigation tree, which amounts to creating a representation structure of a “LocationPath” and inserts it as new leaf of the evaluation tree. It is this representation structure which provides the link between the branch of the evaluation tree and the branch of the navigation tree. In the case of a “LocationPath” of which at least one “Step” contains one or more predicates, the evaluation tree descends to the “Step” entity in order to link the sub-expression corresponding to the predicate to its parent sub-expression. Further to this creation, the navigation target is inserted at the start of that new branch, at a step 703, and its link to the “LocationPath” from which it came is updated as well as its type indicating that it represents the first “Step” of the path. An evaluation target associated with the current navigation target is then created by the target manager 124, at a step 704. This evaluation target essentially comprises information representing an evaluation status and the possible solutions encountered during the evaluation. The link between the evaluation target and the compiled navigation target is stored in the evaluation target, during a step 705. Finally, this evaluation target is inserted into the first list of targets of the stack of evaluation targets of the target manager 124, at the step 706, Next, step 510 is returned to.

If, during the step 701, it is determined that the navigation target does not belong to a new absolute path, during a step 707, it is determined whether the navigation target belongs to the start of a relative path, that is to say a new “LocationPath”, or whether the navigation target belongs to a new “Step” in the current “LocationPath”. The ambiguity is resolved by the context of the semantic parser 112 which knows whether it is already in the construction of a “LocationPath” or not. If the navigation target belongs to the start of a relative path, a representation of the new “LocationPath” is created, during a step 708, and becomes the current “LocationPath” for the semantic parser 112.

Next, during a step 709, it is determined whether the navigation tree already contains a branch or not. If the navigation tree contains no branch, a navigation target denoted “root” is created during a step 710. Next, during a step 711, a new navigation branch is created. The two targets created respectively at step 710 and 700 are inserted on that new branch during a step 712. Next, during a step 713, an evaluation target corresponding to the “root” target is created and inserted in the first list of targets of the stack of targets of the target manager 124. This target is connected to the “root” target at a step 714. Next, the following token is proceeded to and step 504 is returned to.

If it is determined, during the step 707, that the navigation target belongs to a new “Step” in the current “LocationPath”, that is to say that it is not the first “Step” in that “LocationPath”, or if it is determined, during the step 709, that the navigation tree already contains a branch, the semantic parser 112, during a step 715, inserts the compiled navigation target created at step 700 into the current navigation branch. Next, during a step 716, the newly inserted target is connected to the target which precedes it on the branch and the link of that preceding target to the newly inserted target is updated. Next, the following token is proceeded to and step 504 is returned to.

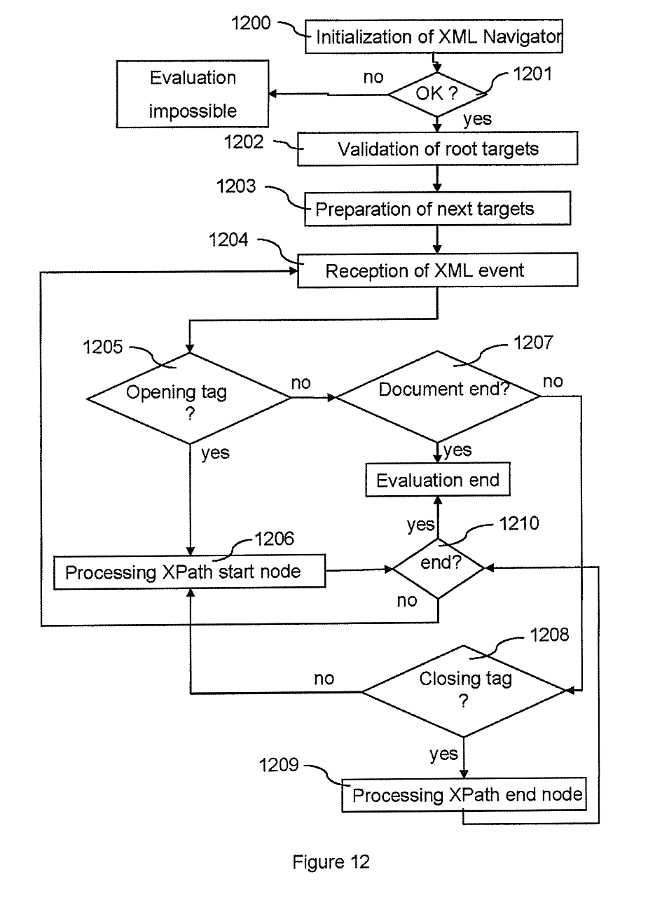

The evaluation of an XPath expression takes place in two steps, respectively described with reference to FIGS. 11 and 12. The first step, illustrated in FIG. 11, consists of launching the execution of all the calculation sub-expressions associated with the nodes of the evaluation tree, which corresponds to step 446 of FIG. 4. First of all, the expression corresponding to the root node of the evaluation tree (see FIG. 11) is retrieved during a step 1100. On the basis of this root node, the child nodes are gone through during a step 1101, until a leaf of the tree is reached. For each node encountered during this going through, the associated sub-expression has its evaluation status set to “in course of processing”. When a leaf of the evaluation tree is reached during the step 1101, the execution of the associated sub-expression is activated at a step 1102.

Then, during a step 1103, it is determined whether a result is available without needing XML information. If yes, this result is propagated to the parent sub-expression (preceding node in the tree) at a step 1106. When during a step 1107 of sending up the result, the parent node has several children, the result is placed on standby for the result of all the children in order to aggregate the results of the child nodes to calculate the result of the parent node, during a step 1108. The propagation of the result of the node resumes when all the child nodes have a result which permits the aggregation during the step 1108. Further to this aggregation, the result sending up continues with the iteration of the steps 1106 to 1108, until the root node of the evaluation tree is reached, the result of the test of step 1106 then being negative. When this node is reached, the current result corresponds to a result for the XPath expression and is output to the application during a step 1109.

If, during the step 1103, it is determined that the result is not available without needing XML information, which is the case, typically, for a navigation sub-expression, the sub-expression is placed on standby for XML data, during a step 1104.

By way of example, in FIG. 8, the leaves of the evaluation tree are the “ExprResults” 865 and 867 corresponding to the first and third arguments of the function call and the “LocationPaths” at the end of the branches 866 and 868 correspond to the second and fourth arguments. Typically, step 1103 would yield “true” for the first two whereas the last two would be placed on standby for XML data at the step 1104. The following step 1105 makes it possible to continue going through the other branches of the evaluation tree.

As illustrated in FIG. 12, the second principal step of the processing consists of the retrieval of the XML information 104 for the purpose of the resolution of the sub-expressions placed on standby for XML data at step 1104, typically the navigation sub-expressions. This corresponds to step 448 of FIG. 4. It is the execution controller 122 which carries out this part, assisted by the target manager 124. The initialization of this second step was prepared by the target manager at steps 706 and 713. The following portion of the processing takes place according to the steps described in FIG. 12. During a step 1200, the XML navigator 103 is initialized with the XML document 104 relative to which the application 101 wishes to evaluate one or more XPath expressions.

Next, during a step 1201, it is determined whether the XML navigator 103 is ready to send XML events, in which case the target manager 124 marks its initial evaluation targets, during a step 1202, as “intermediate solution”, positions a depth index at “0” which corresponds to the depth in the XML document or relative to the initial evaluation context (in the case of relative “LocationPaths”); then during a step 1203, prepares the next targets that are to be processed. To that end, the target manager 124 analyzes, for each of the initial targets, the associated compiled navigation target. The target manager 124 inserts, into its stack of targets, a new list of evaluation targets to consider at the next depth. These new targets are linked, for each initial evaluation target, to the next compiled navigation target(s) of the compiled navigation target associated with the initial evaluation target. The next compiled navigation targets are found by advancing along the different navigation branches.

By way of example, with reference to FIG. 8, CNC10 and CNC20 are the compiled navigation targets associated with the initial evaluation targets CE10 and CE20 of the target manager 124. Step 1203 then consists of creating two evaluation targets CE11 and CE21 connected to CNC11 and CNC21. Once created, the new evaluation targets CE11 and CE21 have their link to their parent target updated with the evaluation target which precedes them (CE10 and CE20) in the target stack of the manager 124.

Further to step 1203, during a step 1204, the XPath processor 102 receives an XML event 104 via the XML navigator 103. This event is saved in memory 131 of the XPath navigator 123.

Next, during a step 1205, it is determined whether the XML event consists of an XML element start and, if yes, step 1206 is proceeded to. Otherwise, during a step 1207, it is determined whether the XML event consists of the end of the XML document 104 and, if yes, the evaluation of the XPath expression terminates. Otherwise, during a step 1208, it is determined whether the event consists of an XML element end and, if yes, step 1209 is proceeded to. Otherwise, step 1206 is proceeded to.

Thus, if the event is an event signaling an XML node of text or comment type, the processing continues during one of the steps 1206 and 1209, the text and comment nodes comprising two events, node start and node end.

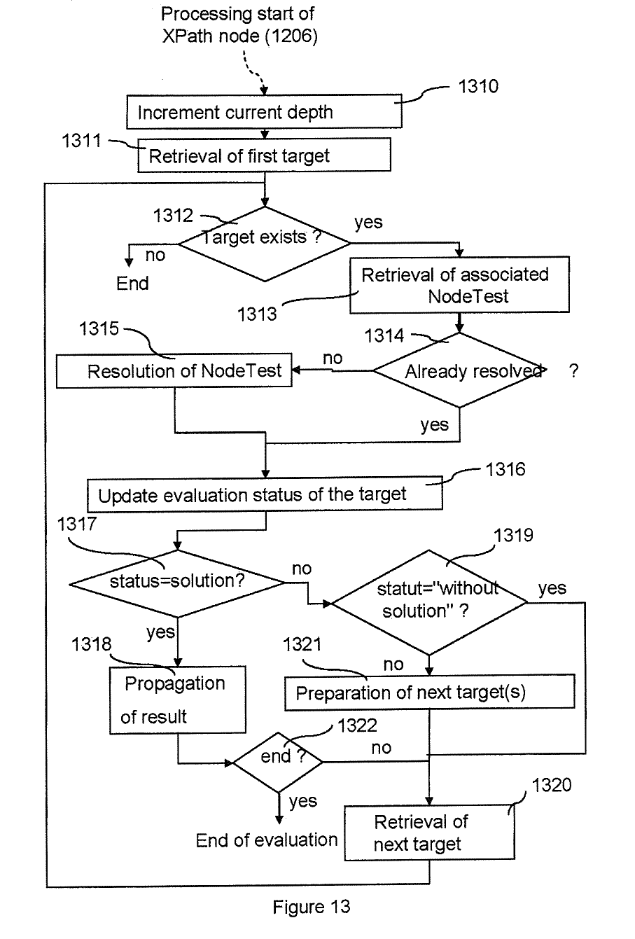

In the case of an XPath node start, at the step 1206, the target manager 124 increments its depth index by “1”, at a step 1310, as illustrated in FIG. 13. Next the target manager 124 retrieves, during a step 1311, the first target from the list corresponding to the current depth. Next, during a step 1312, it is determined whether at least one evaluation target is present in that list of targets, and, if yes, the corresponding “NodeTest”, retrieved via the compiled navigation targets of the evaluation targets, is selected at a step 1313. Otherwise, step 1206 terminals and the following XML event is passed on to during the step 1204. With reference to the example of FIG. 8, at the depth “1”, a single “NodeTest” 869 is activated, and it corresponds to verifying that the name of the current element is equal to “bookstore”. During a step 1314, it is determined whether the “NodeTest” selected at step 1313 has already been resolved for the current depth. If that is the case, the current evaluation target has its evaluation status updated during a step 1316, depending on the result of the “NodeTest”. If the “NodeTest” has not yet been resolved, it is so resolved at a step 1315 which consists of really performing the tests on the current node. According to the XPath specification, it may be a matter of testing the name or the type of the current node. As each “NodeTest” is associated with at least one compiled navigation target and thus indirectly with an evaluation target, the evaluation status of these latter may thus be updated during the step 1316. During this step 1316, the evaluation status of the evaluation target may take different values:

“Potential solution” if the navigation target associated with the evaluation target contains predicates and if it is a leaf on a navigation branch,

“Potential intermediate solution” for the same case as previously but for a non-leaf compiled navigation target,

“Intermediate solution” if the evaluation target is entirely attained and its associated compiled navigation target is not a leaf,

“Solution” if the evaluation target is entirely attained and its associated compiled navigation target is a leaf,

“Without Solution” if the evaluation target is not attained.

During a step 1317, it is determined whether, during the step 1316, there are evaluation targets attaining the “Solution” stage. If yes, the current node is propagated towards the parent evaluation target at a step 1318 described later. Otherwise, during a step 1319, it is determined whether the status of the evaluation target is the value “Without Solution”. If yes, during a step 1320, the following target is proceeded to and step 1312 is returned to. Otherwise, the next evaluation target or targets linked to the current evaluation target are prepared during a step 1321.

The two combined tests 1317 and 1319 respectively make it possible to send up a result for a branch of the navigation tree or to stop the search along a branch of the tree. The other values of evaluation statuses, “intermediate solution”, “potential intermediate solution” and “potential solution” lead to step 1321, equivalent to step 1203: given an evaluation target, determination is made in its associated compiled navigation target of what the next navigation targets are, following “Step” or belonging to a “Predicate”, in the navigation tree. For each target situated at the same depth or at a depth +1, an evaluation target is respectively created and inserted in the list of current targets or in the list of targets for the next depth. This makes it possible to resolve the “AxisSpecifier” in advance. Further to step 1321, the following evaluation target in the current list is proceeded to during the step 1320, until the last target has been attained, the result of the test of step 1312 becoming “false”. When there is no further evaluation target for the current list of targets, step 1206 terminates and step 1204 is returned to until the end of the document has been reached.

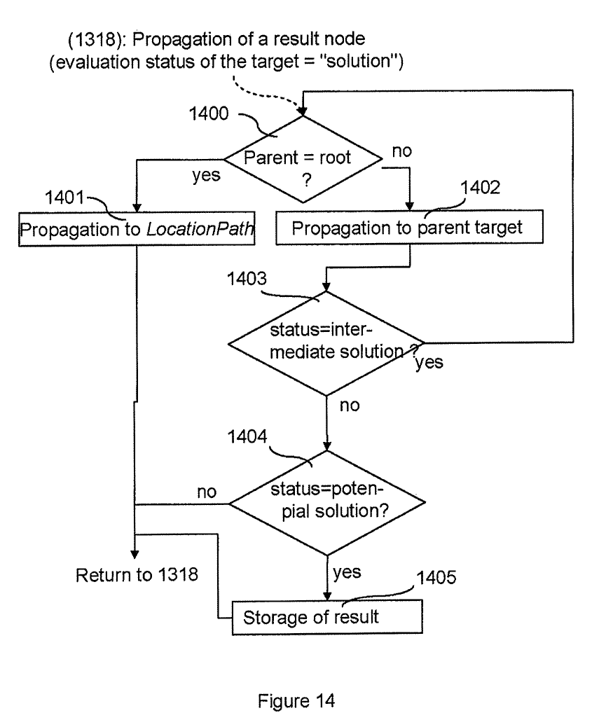

The propagation of the results carried out during the step 1318 consists, for an evaluation target of which the status has the value “Solution”, of propagating the result node as far as the root of the corresponding branch in order then to transfer it to the associated leaf of the evaluation tree. Typically, in the example of FIG. 8, the evaluation target corresponding to CNC13 would have its status set to “Solution” on an XML element start named “title”. The propagation of the result of step 1318 consists of sending the XPath node representing that event up to the evaluation target corresponding to CNC10. Next, via the link 861, this result is sent to the “LocationPath” 866 on standby for XML data since step 1104. To that end, as illustrated in FIG. 14 which details step 1318, the parent evaluation target of the current target is searched for. During a step 1400, it is determined whether that parent evaluation target is a “root” evaluation target, that is to say of which the associated compiled navigation target is a root of a navigation branch. If that is the case, the result is provided to the parent “LocationPath” during a step 1401. Next, if that result makes it possible to eliminate all the navigation sub-expressions on standby for XML data since step 1104, which is determined during the step 1322 of FIG. 13, the evaluation step 448 of FIG. 4 is terminated. Otherwise step 1320 is returned to. If, during the step 1400, it is determined that the parent evaluation target is not a “root”, the result is passed to that parent evaluation target at a step 1402, and then it is determined whether its evaluation status is “intermediate solution”, at a step 1403. If yes, step 1400 is returned to until the root or a parent target is reached with a status different from “intermediate solution”. Otherwise, during a step 1404, it is determined whether the status is “potential intermediate solution”. Otherwise, that is to say if the status is “without solution”, the arriving result is disregarded and step 1318 is returned to if the status is “potential intermediate solution”, the result is placed on standby at the level of the evaluation target, during a step 1405, until its complete resolution.

It is noted that the passage from the status of “potential solution” to that of “solution”, whether or not intermediate, is made at step 1107 where a sub-expression representing a predicate possesses a result and sends it to its parent “Step”.

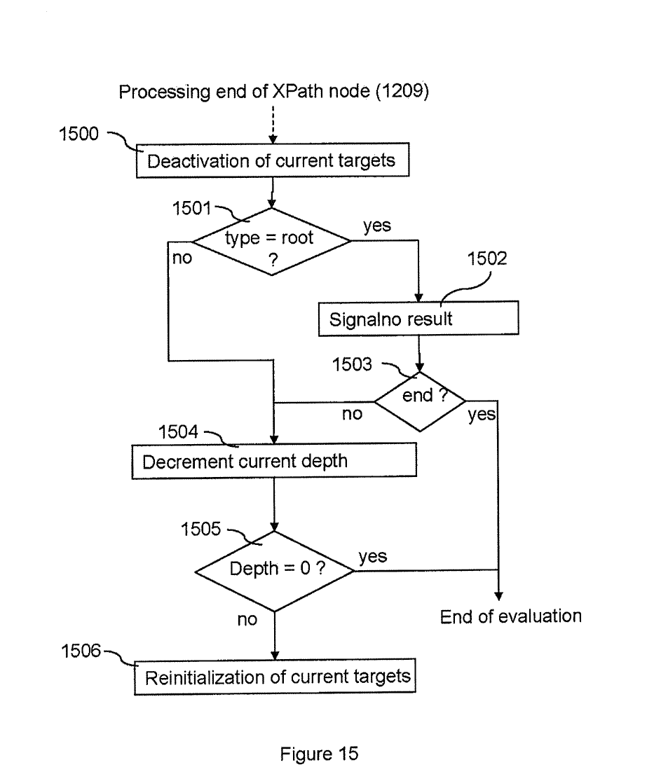

Returning to FIG. 12, during the step 1209, that is to say in the case of an end of XPath node, deactivation is carried out, during a step 1500 illustrated in FIG. 15, of the evaluation targets belonging to the list of targets corresponding to the current depth in the target stack of the manager 124. The deactivation may consist either of removing them from the target stack, or of associating them with an “active” “inactive” status which is, in this case, initialized to “inactive”. Next, during a step 1501, it is determined whether, from among the evaluation targets to deactivate, some of them correspond to root evaluation targets, this information being carried by the type of the associated compiled navigation target. If this is the case, a signal is sent to the parent “LocationPath” to indicate that no solution has been found for the current evaluation context, during a step 1502. This make it possible to release the sub-expressions on standby for XML data since step 1104 and to send up an empty result during steps 1106 to 1108 and, possibly, to output an evaluation result during the step 1109.

Next, during a step 1503, it is determined whether this propagation leads to an end of evaluation. Otherwise, a step 1504 is proceeded to, during which the current depth is decremented by “1”. Next, during a step 1505, it is determined whether the depth has the value “0”, this meaning that the end of the XML data has been reached. If yes, the evaluation terminates. Otherwise, the evaluation targets located at that new depth are reinitialized, during a step 1506, the initialization concerning the evaluation statuses and the status of the associated “NodeTests”, for the purpose of an evaluation on new XML data during the step 1204, if the end of evaluation is not reached, which is determined during the step 1310 illustrated in FIG. 13.

As may be understood on reading the preceding description, the implementation of the present invention provides a means for evaluating XPath expressions in a streaming environment, by an analysis of its expressions in order to distinguish the calculation part from the part dependent on XML data, while preserving the link between these two parts for the purpose of the sending of results and while limiting their storage.

The main steps of the method of the third and fourth aspects of the present invention are represented in FIG. 16: during a step 16017 at least one expression is supplied to the XPath processor 1702 (see FIG. 17). During a step 1602, a lexical analysis makes it possible to represent each expression by a series if tokens corresponding to the grammar defined by the XPath specification. During a step 1603, it is determined whether all the tokens are known. If yes, during a step 1604, a grammatical analysis is carried out which makes it possible to construct a representation of each expression. In particular, during this step 1604, the navigation sub-expressions are identified, step 1604a, and divided up into steps, step 1604b and each step has attributed to it a recipient for its evaluation results, step 1604c.

Step 1604 is detailed with reference to FIG. 18.

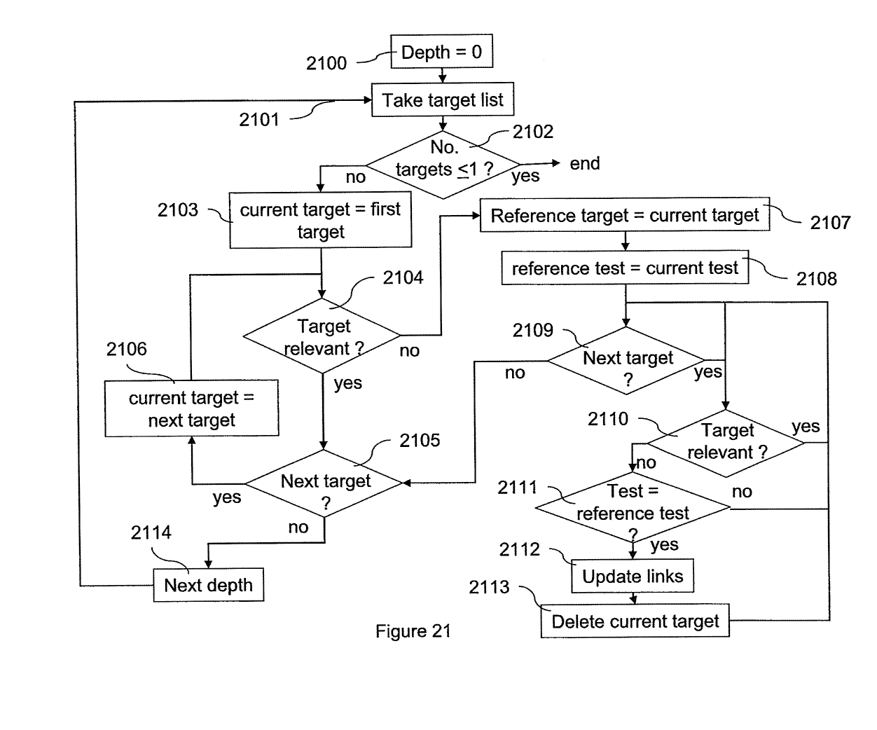

Further to step 1604, during a step 1605, it is determined whether the representation thus constructed is valid. If yes, a grouping step 1606 is carried out enabling the redundant and non-significant steps to be grouped together. If the result of one of the steps 1603 or 1605 is negative, an invalid expression signal is output. Step 1606 is detailed in FIG. 21. Next, a step 1607 of launching the evaluation of the expressions is carried out. During a step 1608, it is determined whether the entirety of the results is available. Otherwise, an evaluating step 1609 is carried out on the basis of an XML document. Further to step 1609 or if the result of step 1608 is positive, the steps terminate.

FIG. 17 describes a context of implementation of the present invention. The typical scenario for use of the present invention involves an application 1701 manipulating XML data extracted by one or more XPath processors 1702 by virtue of one or more XML parsers (or navigators) 1703 working on an XML data stream 1704. The XPath processor 1702 comprises three main entities:

a compiler 1721 which analyzes the expressions and translates them into an internal representation, as described with reference to FIG. 18. This compiler 1721 is composed of two parsers, one 1761 being lexical, and the other 1762 semantic;

an execution control unit 1722 which manages the communication with the application 1701, the interactions between the different modules and takes on the task of evaluating the nodes. This execution control unit 1722 is in particular composed of an evaluation target manager 1771 responsible for the resolution of the location path steps composing the navigation sub-expressions and

a navigator 1723 which enables the execution control unit 1722 to communicate generically, with any XML navigator 1703, and to represent and store the XML events in the form of XPath nodes in a navigation context 1781. This navigator 1723 also makes it possible to operate the XPath processor 1702 in “pull” mode (it controls the traversal in the XML document 1704 and the XML navigator 1703) or “push” (it listens for the XML data extracted by the XML navigator 1703 at that time controlled by the application 1701).

The two main steps of the evaluation of one or more XPath expression(s) are:

the analysis for the purpose of compilation (see, below, the construction of the internal representation), and

the actual evaluation (see, below, the evaluation of an XPath expression, with respect to an XML document).

The invention is preferentially implemented in the XPath processor or processors 1702.

FIG. 18 illustrates the construction of the internal representation. One or more XPath expressions to evaluate are specified by a user or stored beforehand in a file read by the application or else derive from the execution at the application level of a program (for example an XSLT or XQuery processor) generating XPath requests. These expressions are received one after the other, during a step 1801. The object of the steps which follow is to translate the XPath expressions received by the XPath processor 1702 into a structure, for example one or more trees, which the execution controller 1722 will use for the evaluation. According to a preferred embodiment, the internal representation is composed at the same time by an instructions tree and by a tree of compiled navigation targets, a compiled navigation target representing a “Step” of a “LocationPath”.

A lexical analysis is carried out during a step 1802. This step consists of analyzing the characters which represent the current XPath expression one by one and of grouping them into tokens. These tokens may represent reserved tokens, suitable for the specification, such as the character “/”, the token “::” . . . or else simple digits or characters. Step 1802 is carried out by the lexical parser 1761 which possesses a table of predefined tokens according to the XPath grammar considered (1.0 or 2.0).

Further to the decomposition into tokens carried out during step 1802, it is determined during a step 1803 whether the tokens generated are valid. If during this step 1803, one of the tokens is analyzed as not permitted or unknown by the lexical parser 1761, the compiler 1721 stops and informs the XPath execution controller 1722 of the non-compliance of the expression, at a step 1809. This expression cannot then be evaluated. A variant consists of ignoring the unrecognized token and of containing the compilation. In the case of several expressions to evaluate simultaneously, any invalid expression is rejected from the evaluation.

If the test step 1803 leads to a set of tokens that are considered as valid by the lexical parser 1761, during a step 1804, the semantic analyzer 1762 retrieves the first token generated at step 1802. On the basis of that token, the semantic parser 1762 attempts, during a step 1805, to identify an elementary sub-expression, for example a function call (“FunctionCall”), an equality expression (“EqualityExpr”), a location path (“LocationPath”), etc. If the current token does not enable such an identification, the semantic parser 1762 reads a new token while verifying beforehand that there is one, during a step 1806. On the contrary, if an elementary sub-expression is recognized during a step 1805 by the semantic parser 1762, the semantic parser 1762 determines during a step 1807 whether it is a navigation type sub-expression. Otherwise, the sub-expression identified is inserted into the instruction tree at a step 1808 and the semantic parser 1762 returns to step 1806.

If it is a navigation sub-expression, the semantic parser 1762 reads, during a step 1810, one or more tokens which follow the tokens implemented during the step 1804, in order to construct a representation of the current location path step (“Step”) at a step 1812, which representation is given the name “compiled navigation target”. The representation of the location path step (“step”) thus constructed is stored in the semantic parser 1762 as parent compiled navigation target of the possible next location path steps (“steps”) to construct, during a step 1813. Next, step 1810 is returned to in order to in order to continue the processing of the tokens of the list of tokens so long as these correspond to components of the location path step (“Step”) corresponding to a positive result of step 1811. For each location path step (“Step”) so identified, the semantic parser 1762 constructs an associated compiled navigation target during the step 1812. If the token read does not correspond to a component of a Step, that is to say if the result of the step 1811 is negative, the semantic parser 1762 attempts to use that token to identify a new sub-expression during a new step 1805.

The semantic parser 1762 reiterates the steps 1810, 1811, 1812 and 1813 until no other token is available, the result of step 1810 then being negative, or else when the token read does not correspond to a component of a Step, the result of step 1811 then being negative.

When there remains no further token to read, the result of step 1806 or of step 1810 then being negative, the XPath compiler 1721 considers the following expression, by first of all determining whether there is at least one, during a step 1814, and, if yes, by retrieving it during a new iteration of step 1801, prior to returning to step 1802.

If no further expression remains, during a step 1815, termination is made of the step of constructing the internal representation by the grouping together of the redundant compiled navigation targets. This grouping step 1815 is described with reference to FIG. 21.

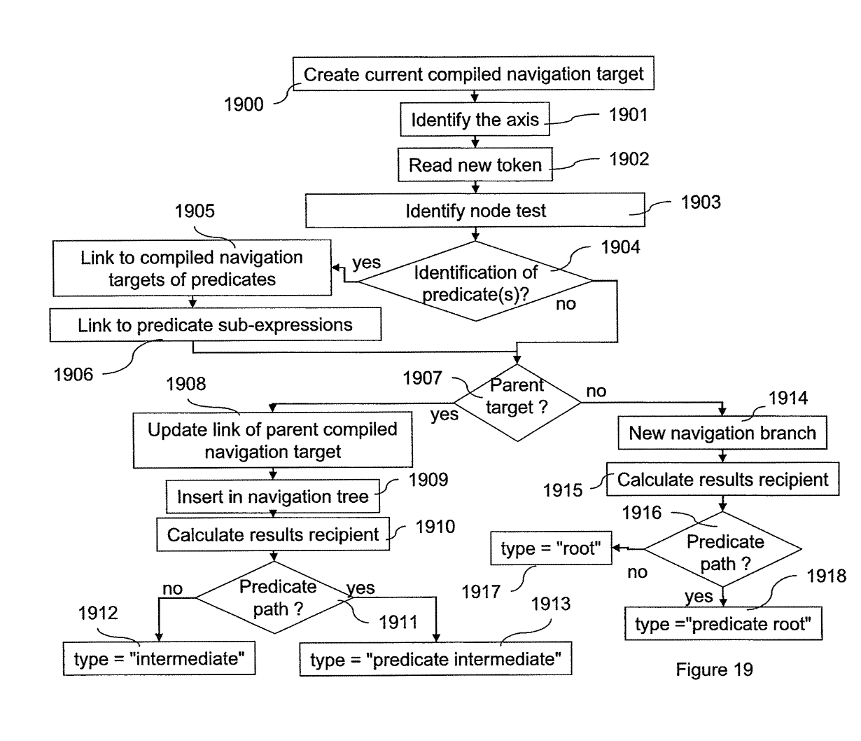

FIG. 19 gives the detail of step 1812 relative to the construction of the representation of a location path step (“Step” in the specification XPath). This representation is termed “compiled navigation target” since it bears information on structure and value of the XML nodes sought in the XML document 1704 and since the structure information thus involves a navigation.

More particularly, an axis (“AxisSpecifier”) specifies the type of tree relationship (that is to say the search direction) between a context node (solution of the preceding step) and the nodes to locate. The axis may also provide an item of information on the type of node (for example “attribute::”) and also gives a statement as to the depth in the XML document 1704 at which the potential solutions are situated.

The node test (“NodeTest”) provides an item of information either as to the type of node sought or as to its name. Lastly, one or more predicates (“Predicates”) enable, possibly, the solutions of a location path step (“Step”) to be filtered.

Step 1812 of constructing the representation of the current location path step consists, for the semantic parser 1762, of creating a compiled navigation target during a step 1900. At the time of this creation, the semantic parser 1762 makes an entry in a field of the compiled navigation target which makes it possible to know which location path (“LocationPath”) the compiled navigation target belongs to. Next, a step 1901 consists of determining what axis value from among the thirteen possible values defined by the XPath syntax the current token corresponds to.

Further to step 1901, a new token is read during a step 1902. The node test is identified during a step 1903. To that end, the semantic parser 1762 identifies, on the basis of the current token or on the basis of the new token read, either a type of node or a name, qualified or not, that any candidate node for the resolution of the current location path step (“step”) must satisfy. Further to the identification of the node test, the semantic parser 1762 determines whether it can identify possible predicates, during a step 1904, that are associated with the current location path step (“step”). For this, a predicate being by definition an XPath expression between the characters ‘[’ and ‘]’, the construction of a predicate is carried out according to the construction steps 1804 to 1813 of FIG. 18. If at least one predicate is identified, during a step 1905, a link is preserved, at the level of the current location path step (“step”), to the first compiled navigation target of each predicate. Next, at a step 1906, the current compiled navigation target keeps a link to the sub-expression(s) that correspond to the predicate(s), this being in order to determine during the evaluation whether its predicates are resolved or not.

Next, during a step 1907, the semantic parser 1762 determines whether the current compiled navigation target possesses a parent compiled navigation target saved in memory of the compiler during the step 1813. If yes, the semantic parser 1762 updates the parent-child link between the parent compiled navigation target and the current compiled navigation target, at a step 1908. Next, during a step 1909, the current compiled navigation target is inserted into the navigation tree which will represent the current location path. For this, the semantic parser 1762 relies on the value of the axis of the current compiled navigation target: if it is an axis of “child”, “descendant” or “descendant-or-self” type, the current compiled navigation target is inserted into the navigation tree as child of the parent compiled navigation target, that is to say at a level corresponding to a level of depth incremented by one, relative to that of the parent compiled navigation target. If the axis has the value “attribute”, “namespace” or “self”, the current compiled navigation target is inserted as sibling of the parent compiled navigation target, that is to say at the same depth in the navigation tree. If the axis has the value “parent”, the compiled navigation target is inserted at a level of depth decremented by one, relative to the parent compiled navigation target. If the axis has the value “ancestor” or else “ancestor-or-self”, the current compiled navigation target is inserted at level “1” of the navigation tree as child of the root compiled navigation target.

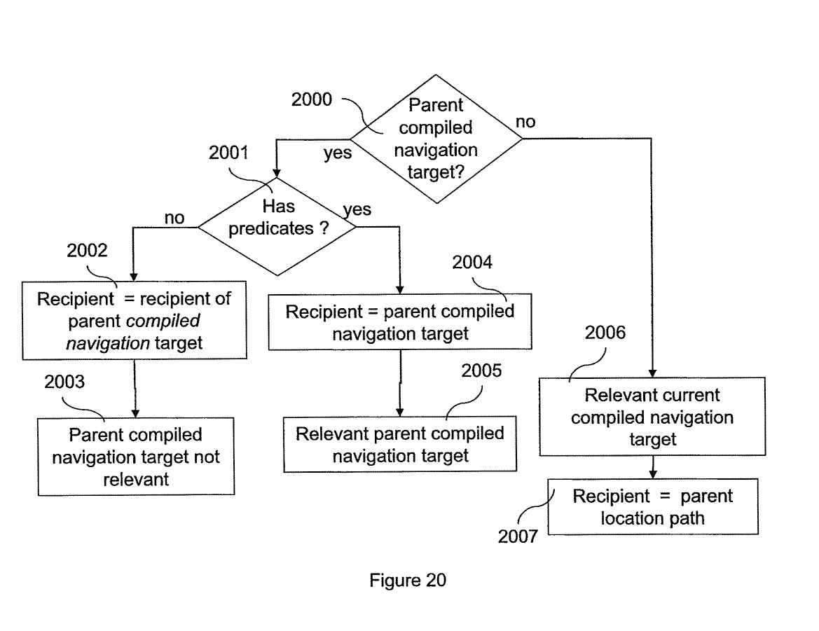

Further to this insertion, the semantic parser 1762 calculates the recipient for the results of evaluating the current compiled navigation target at a step 1910. For this, it operates according to the steps of FIG. 20.

As is seen in FIG. 20, during a step 2000, it is determined whether there is a parent compiled navigation target. If yes, the semantic parser 1762 determines whether that parent compiled navigation target contains at least one predicate, at a step 2001. If that is not the case, the XPath compiler 1721 adds at 2002 the item of information on recipient for the results of the current compiled navigation target, this item of information having as its value the recipient for the results of the parent compiled navigation target. Next the parent compiled navigation target is marked as not relevant as regards the propagation of the results, during a step 2003. If, on the contrary, the parent compiled navigation target contains at least one predicate, the XPath compiler 1721 adds at 2004 the item of information on recipient for the results of the current compiled navigation target with as its value the parent compiled navigation target. The current compiled navigation target is then marked as relevant at a step 2005.

Step 2006 of FIG. 20 corresponds to the case in which the current compiled navigation target is the first of a location path, that is to say the case in which the result of step 1907 is negative. In this case, the current compiled navigation target is marked as relevant during that step 2006 and the item of information on recipient for the results is added to that current compiled navigation target with as its value the parent location path at 2007.

It is seen that steps 2006 and 2007 correspond to the case of step 1915 followed by a negative result during the step 2000.

Returning to step 1910 of FIG. 19, once the recipient has been identified, the type of the current compiled navigation target is determined, that type being used by the execution controller 1722 during the evaluation. For this it is determined during a step 1911 whether the current compiled navigation target possesses predicates. If yes, its type takes the value “predicate intermediate” during a step 1913. Otherwise, its type takes the value “intermediate” during a step 1912.

If the result of step 1907 is negative, that is to say if the semantic parser 1762 has not yet saved the parent compiled navigation target at 1813, the current compiled navigation target creates a new branch in the navigation tree, during a step 1914. Next, its recipient and its level of relevance are initialized during a step 1915, by performing the steps 2000 and 2006. Then, during a step 1916, it is determined whether at least one predicate is present. If the current compiled navigation target contains no predicate, its type is initialized to “root”, during a step 1917. Otherwise, its type takes the value “predicate root” during a step 1918.

As can be seen with reference to FIG. 21, which concerns the factorization or the grouping together of the compiled navigation targets, in order to reduce the memory cost of the representation of the compiled XPath expressions, the relevancy measurement associated with the compiled navigation targets may be used. This consists of factorizing the intermediate compiled navigation targets identified as not relevant during the step 2003, in the processing and the propagation of the results.

For greater legibility, this factorization is described with reference to step 1815, as consecutive to the construction of the internal representation. Similarly, the concept of “grouping together of compiled navigation targets” will be considered identical to the concept of “factorization of compiled navigation targets”. However, this factorization could be integrated into the steps of constructing that representation, in particular during the steps of calculating the recipient for the results, in particular step 1910. The factorizing step 1815 starts with a step 2100 during which an index of current depth in the navigation tree is set to “0” Next, during a step 2101, the compiler 1721 retrieves the list of compiled navigation targets for the current level of depth. Next, during a step 2102, it is determined whether the list contains at most one compiled navigation target. If yes, the factorization terminates. Otherwise, the compiler 1721 selects the first compiled navigation target from the list, during a step 2103.

During a step 2104, it is determined whether the first compiled navigation target of the list is relevant. If yes, the compiler 1721 determines whether there is a following compiled navigation target, during a step 2105 and, if yes, the following compiled navigation target becomes the current compiled navigation target at 2106 and step 2104 is returned to.

If the current compiled navigation target tested at 2104 proves to be not relevant, the current compiled navigation target becomes the reference compiled navigation target, during a step 2107. Next, the node test of the reference compiled navigation target is saved as reference node test, at a step 2108. Next, during a step 2109, it is determined whether there is a following compiled navigation target. Otherwise, step 2105 is returned to. If no further reference compiled navigation target is available, the traversal of the list resumes starting with the reference target at 2105 (with iterations on 2106). It is observed that the iteration passing by step 2109 consists of varying the reference compiled navigation target from the current compiled navigation target up to the last compiled navigation target of the list. If the result of step 2109 is positive, the following compiled navigation target is proceeded to and it is determined, during a step 2110, whether the following compiled navigation target, retrieved from the current list of compiled navigation targets, is relevant. Otherwise, the compiler 1721 compares its node test to the reference node test, during a step 2111. If the current node test has the same value as the reference node test, the reference compiled navigation target is updated during a step 2112 with the links of the current compiled navigation target. Lastly, during a step 2113, the current compiled navigation target (obtained at 2109) is destroyed then grouped together in the reference compiled navigation target and step 2109 is returned to.

If the result of the step 2110 is positive, the compiled navigation target being detected as relevant, the compiler 1721 returns to step 2109. Similarly, if the comparison between the node tests of step 2111 is negative, step 2109 is returned to, this being done until the end of the current list is reached. In this case, the result of the step 2109 is negative and step 2105 is returned to at which it is verified whether the current compiled navigation target has a following compiled navigation target. If that is the case, step 2106 is returned to. Otherwise, the processing is terminated for the list of current compiled navigation targets retrieved during the step 2101. When the result of step 2105 is negative, during a step 2114, the next depth is proceeded to and step 2101 is returned to until a depth is reached for which there is no compiled navigation target, the result of step 2102 then being negative.

The updating of the links, during the step 2112, consists for a given current compiled navigation target Ci and reference compiled navigation target Cref, of adding the next compiled navigation target(s) of Ci to the list of the child compiled navigation targets of Cref.

The deletion of the redundant compiled navigation targets as well as the links to the recipients for the results are illustrated by examples in FIGS. 22 and 23. In FIG. 22, in the left expression 2250, it can be seen that in case of a function call containing several location paths, the majority of the compiled navigation targets associated with those paths may be grouped together. In the right example 2251, in which the location paths sometimes contain predicates, it is found that the compiled navigation targets named “author” are not factorized. This is due to the fact that one of them is found to be at the leaf of the navigation tree, and thus relevant, whereas the second is found to be an intermediate compiled navigation target that is not relevant. The target named “book” in the right example is found to be factorized since solely one of its children has a predicate, the other having its parent location path as recipient. The fact of not factorizing compiled navigation targets having the same node test but different predicates makes it possible to avoid filtration of the solutions arriving on that compiled navigation target. If such compiled navigation targets were to be factorized, that would imply having to identify in relation to which of the results one of the predicates was evaluated at “true” or at “false”. This would prevent any direct passing up of a result and would slow the evaluation of the XPath expressions.

Once all the compiled navigation targets have been constructed for all the XPath expressions, their evaluation can commence. FIG. 23 represents an internal representation example, prior to the factorization of step 1815, on which the evaluation is based.

In this example, two expressions 2300 are considered and broken down into an instructions tree 2301 and a navigation tree 2302. The root 2303 of the instructions tree groups together the expressions 2300. The navigation tree 2302 contains all the compiled navigation targets created at step 1812. These compiled navigation targets represent the steps of the location path (“Steps”) of the expressions 2300. The compiled navigation target 2310 corresponds to the root of the navigation tree. The compiled navigation targets 2315 and 2316 correspond to compiled navigation targets having been factorized as described with reference to FIG. 21. The compiled navigation targets, 2311, 2313 and 2314, are those which make it possible to resolve an expression of location path type:

the compiled navigation target 2311 corresponds to the results for the location path 2307,

the compiled navigation target 2313 to the results for the location path 2308 and

the compiled navigation target 2314 to the results for the location path 2309.

These compiled navigation targets 2311, 2313 and 2314 each have a link, respectively 2304, 2305 and 2306, to a results recipient.

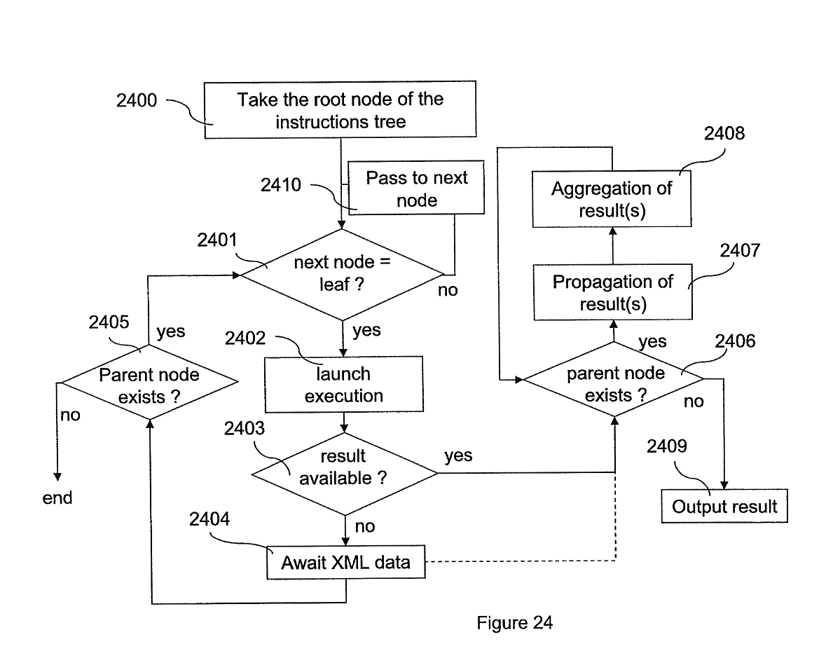

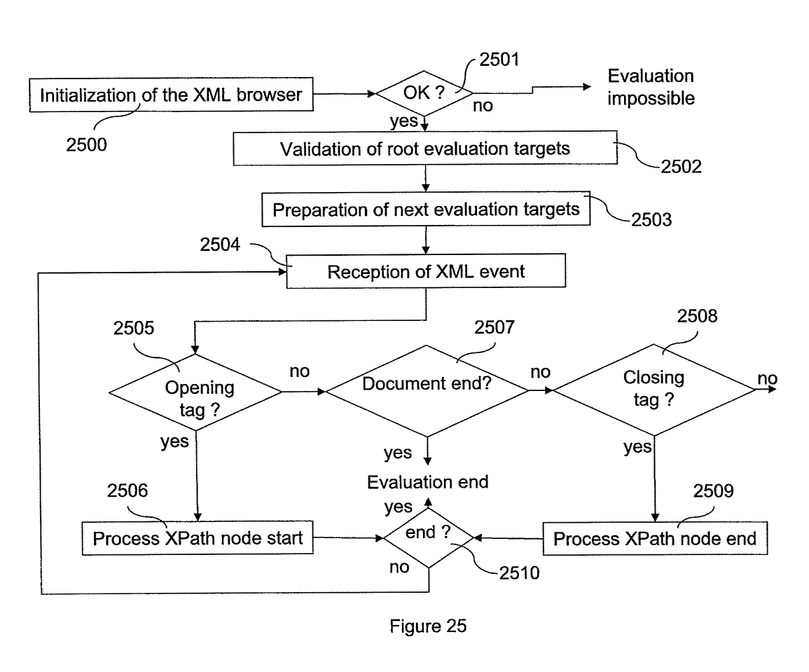

FIGS. 24 and 25 concern an evaluation of an XPath expression, which takes place in two steps. The first step consists of launching the execution of all the sub-expressions associated with the nodes of the instructions tree constructed during the step 1808. First of all, the root node of the instructions tree, 2303 in the example of FIG. 23, is retrieved during a step 2400.

Starting from this root node, it is determined, during a step 2401, whether the following node is a leaf of the instructions tree, for example 2307 or 2308 in the example of FIG. 23, and, if not, during a step 2410, the sub-expression associated with the node has its evaluation status set to “in course of processing” and the following node is proceeded to. Next, step 2401 is reiterated. When the result of the step 2401 is positive, a leaf of the instructions tree having been reached, during a step 2402, the execution of the associated sub-expression is activated.

Then, during a step 2403, it is determined whether a result is available without needing XML information. If yes, this result is propagated to the parent sub-expression, that is to say to the preceding node in the tree, at a step 2406. Next, during a step 2407, a propagation, or passing up, of the result is carried out. For a parent node possessing several children, the result is placed on standby for results of all the children in order to aggregate the results of the child nodes to calculate the result of the parent node, during a step 2408. The propagation of the result of the node resumes when all the child nodes have a result which permits the aggregation during the step 2408. Further to this aggregation, the result passing up continues at the time of new iterations of the steps 2406 to 2408 until the root node 2303 of the instructions tree 2301 is reached which corresponds to a negative result of the test 2406. When this node is reached, the current result corresponds to a result for one of the XPath expressions and is thus output to the application during a step 2409.

If the result of the step 2403 is negative, which indicates that the sub-expression associated with a leaf of the instructions tree 2301 does not have an available result (typically a navigation sub-expression), at a step 2404, the sub-expression is placed on standby for XML data. By way of example, in FIG. 23, the leaves of the instructions tree are the LocationPaths 2307 and 2308 which correspond, for the first of them, to the function call argument “string” and, for the second, to the expression of the main path of the second expression. Typically, the result of the step 2403 is negative and these two sub-expressions are then placed on standby for XML data at step 2404. The LocationPath 2309 is a particular case since it represents an expression of predicate type. It evaluation is triggered by the evaluation target (see description of the second step below) corresponding to the compiled navigation target to which that predicate relates, with reference 2313 in the example of FIG. 23.

Step 2404 consists of inserting, at the level of the evaluation targets manager 1771, the evaluation target or targets corresponding to the root compiled navigation target or targets 2310 of the navigation tree 2302. Then, during a step 2405, it is determined whether there is a parent. If yes, step 2401 is returned to. Otherwise, the processing ends. Step 2405 thus makes it possible to continue the traversal of the other branches of the instructions tree 2301 until the instructions tree has entirely been traversed.

The second main processing step consists of retrieving XML information 1604 for the purpose of resolving the sub-expression placed on standby for XML data at step 2404, typically the navigation sub-expression identified during the step 1807. It is the execution controller 1722 which takes on the task of this part, assisted by the evaluation target manager 1771. The following portion of the processing takes place according to the steps illustrated in FIG. 25.

It is noted here that a compiled navigation target corresponds to at least one evaluation target. As their names indicate, the compiled navigation targets are constructed by the compiler 1721 and serve as a basis for the evaluation of the expressions by the controller 1722 which, via its evaluation target manager 1771, creates an evaluation target, at the time of evaluating a location path step, which bears the information relative to the status of the execution. This distinction between compiled navigation targets and evaluation targets makes it possible to keep intact the navigation tree grouping together all the compiled navigation targets for the purpose of evaluations that are multiple or in parallel. Furthermore, the recipient information calculated at 1910 or 1915 is also present in the evaluation target since the propagation of results is made on all the evaluation targets and not on the compiled navigation targets.

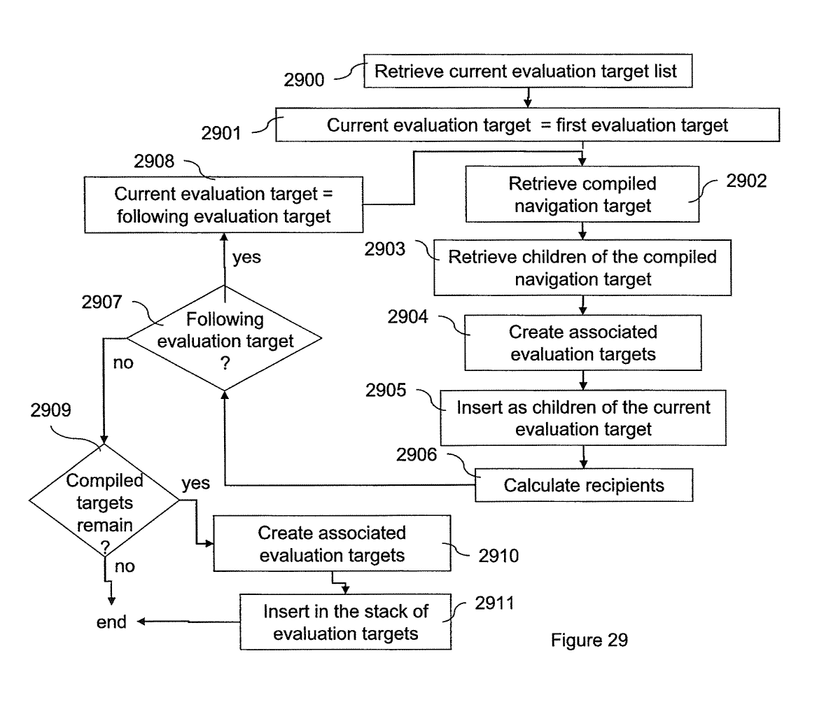

As can be seen in FIG. 25, during a step 2500, the XML navigator 1703 is initialized with the XML document 1704 with respect to which the application 1701 evaluates one or more XPath expressions. Next, during a step 2501, it is determined whether the XML navigator 1703 is ready to send XML events. If not, the evaluation is impossible. If yes, the evaluation target manager 1771 creates one or more initial evaluation targets associated with the root compiled navigation target or targets of the evaluation tree, reference 2310 of the example of FIG. 23. During a step 2502, these root evaluation targets are validated and have their evaluation status set to the value “intermediate solution” The evaluation target manager 1771 positions its depth index at “0”, corresponding to holding the depth, in the XML document or relative to the initial evaluation context, then prepares the next evaluation targets that are to be verified, at a step 2503. This step 2503 is described with reference to FIG. 29. Further to step 2503, during a step 2504, the XPath processor 1702 receives, in the case implementing “push”, or requests, in the case implementing “pull”, an XML event 1704 via the XML navigator 1703. This event 1704 is saved in memory of the XPath navigator 1723 in the form of an XPath node. The following steps 2505, 2507 and 2508, consist of comparing the type of XML event received relative to the different possible types:

step 2505 determines whether it is an XML element start, and, if yes, a step 2506 is proceeded to;

if not, step 2507 determines whether it is a document end, and if yes, the evaluation step terminates,

if not, step 2508 determines whether it is an XML element end, and, if yes, a step 2509 is proceeded to and;

if not, a step (not shown) is proceeded to performing the equivalent of steps 2506 and 2509; As a matter of fact, it is thus an event signaling an XML node of text or comment type, and text and comment nodes are broken down into two events, one being a node start and the other an end node.

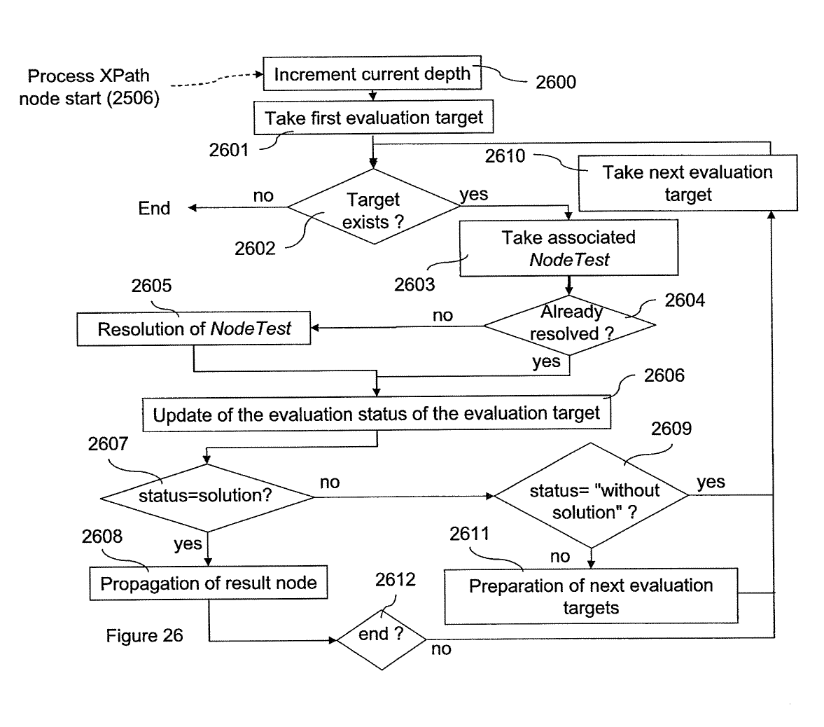

In the case of an XPath node start, at the step 2506, the evaluation target manager 1771 increments its depth index by “1”, at a step 2600 (see FIG. 26). Next the evaluation target manager 1771 retrieves, during a step 2601, the first evaluation target from the list of evaluation targets corresponding to the current depth. This list of evaluation targets is prepared during the step 2503, the first time, then during the step 2611, the following times. Next, during a step 2602, it is determines whether at least one evaluation target is present in that list of evaluation targets. If yes, the corresponding node test (NodeTest) is selected at a step 2603. This node test is retrieved via the compiled navigation target associated with the current evaluation target. Otherwise, step 2506 terminates and the following XML event is passed on to during the step 2504.

With reference to the example of FIG. 23, at the depth “1”, three compiled navigation targets are selected, which use two different tests on the node: “book” and “bookstore”.

The node test corresponding to the evaluation target selected during the step 2601 is selected at step 2603 then, during a step 2604, it is determined whether that node test has already been resolved for the current depth. If that is the case, during a step 2606, the current evaluation target has its evaluation status updated according to the result of the node test. If the node test has not yet been resolved, it is so resolved at a step 2605 which consists of really performing the tests on the current XPath node. According to the XPath specification, it may be a matter of testing either the name, or the type of the current XPath node. After the resolution of the test on the node, the evaluation status of the current evaluation target is updated during the step 2606. During this step 2606, the evaluation status of the evaluation target may take different values:

“Potential solution”, if the evaluation target contains predicates and its associated compiled navigation target corresponds to a leaf of the navigation tree 2302. In this case, each associated predicate is activated (see expression 2312 in the example of FIG. 23);

“Intermediate potential solution”, if the evaluation target contains predicates and its associated compiled navigation target does not correspond to a leaf of the navigation tree 2302. In this case too, each associated predicate is activated,

“Intermediate solution” if the evaluation target is entirely attained and if its associated compiled navigation target is not a leaf of the navigation tree.

“Solution” if the evaluation target is entirely attained and its associated compiled navigation target is a leaf of the navigation tree and

“Without Solution”, if the evaluation target is not attained.

Next, during a step 2607, it is determined whether, during the step 2606, at least one evaluation target attained the “Solution” stage. If yes, the current node is propagated to the recipient for the current evaluation target, at a step 2608. Otherwise, during a step 2609, it is determined whether the status of the evaluation target is the value “Without Solution”. If yes, the following evaluation target in the list is proceeded to during a step 2610 and step 2602 is returned to. Otherwise, during a step 2611, the next child evaluation target or targets of the current evaluation target are prepared and then step 2610 is preceded to.

It is noted that the two combined tests 2607 and 2609 make it possible, respectively, to send up a result for a branch of the navigation tree or to stop the search along a branch of the tree. The other values of evaluation statuses (“intermediate solution”, potential intermediate solution” and “potential solution”) lead to step 2611, described with reference to FIG. 29. When there are no further evaluation targets to test for the current depth, the result of step 2602 being negative, step 2506 terminates and step 2504 is returned to until the end of the document is reached.

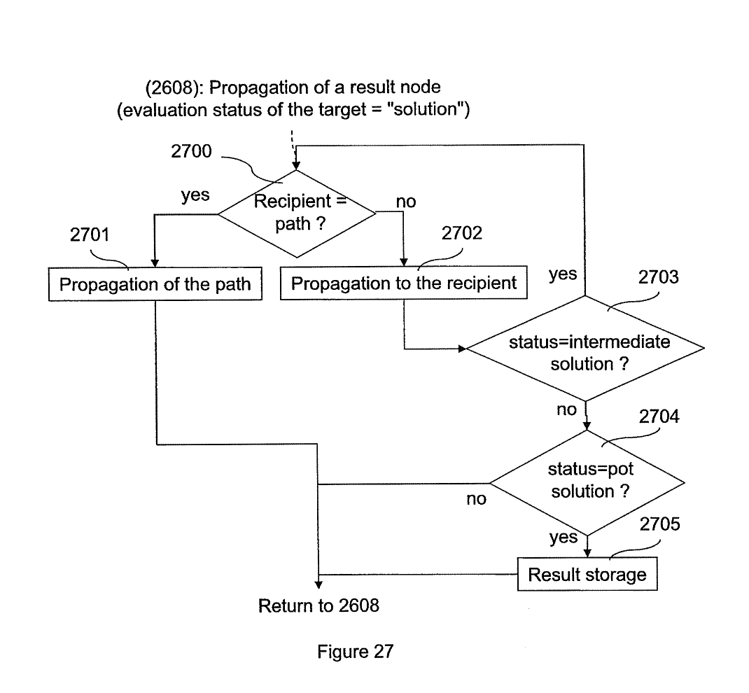

For an evaluation target of which the status has the value “Solution”, the propagation of the results of step 2608 consists in propagating the result node to a relevant parent evaluation target or else directly as far as the parent location path. Typically, in the example of FIG. 23, the navigation target 2311 would have its status set to “Solution” on an XML element start named “title”. The propagation of the result 2608 consists of sending up the XPath node representing that event as far as the parent location path 2307. Next, that result is transmitted to the instruction corresponding to the location path 2307 placed on standby for XML data during the step 2404. For this, as set forth with reference to FIG. 27, which gives the details of step 2608, the recipient for the results of the current evaluation target is searched for.

During a step 2700, it is determined whether the recipient for the results of the current evaluation target is its parent location path. If yes, the result is supplied to the parent location path (LocationPath) during a step 2701 and step 2608 is returned to. Next, during a step 2612, it is determined whether that result enables elimination of all the navigation sub-expression awaiting XML data at step 2404. If yes, the evaluation is terminated. If not, the processing continues during the step 2610. If the test 2700 on the recipient for the results indicates that the recipient does not correspond to a location path, it corresponds to one of its parent evaluation targets. The result is then transmitted to said parent evaluation target, at a step 2702. Next, during a step 2703, it is determined whether the evaluation status of that parent evaluation target is “intermediate solution”. If yes, step 2700 is returned to, until either the parent location path is reached, or a parent evaluation target is reached of which the evaluation status is different from “intermediate solution”.

If the result of the test 2703 is negative, during a step 2704, it is determined whether the status has the value “intermediate potential solution”. If yes, the result is placed on standby at the level of that evaluation target, at a step 2705, until its complete resolution. If the result of step 2704 is negative or further to step 2705, step 2608 is returned to.

The passage from “potential solution” to “solution” (whether intermediate or not) is made at step 2407, at which, for example, a sub-expression representing a predicate, for example 2312 in FIG. 23, possesses a result and transmits it to its parent evaluation target, 2313 in FIG. 23.

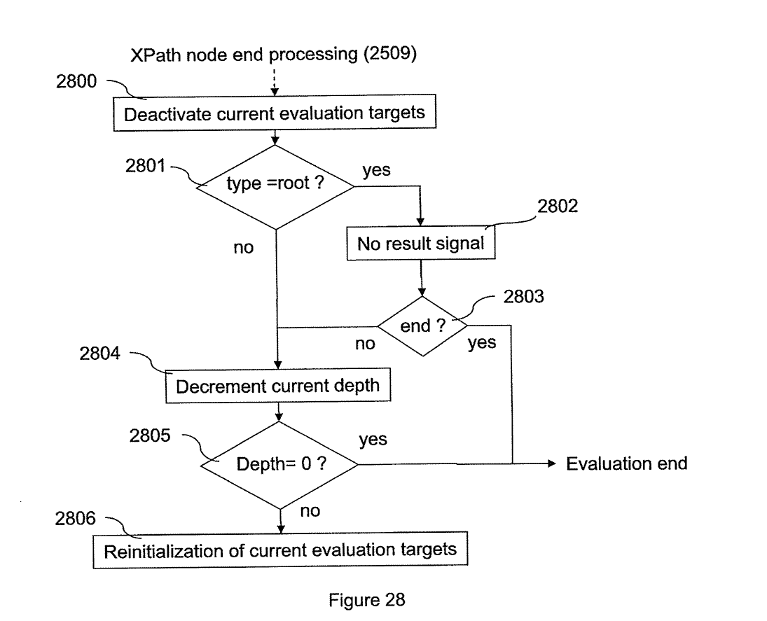

If the result of step 2508 is positive, that is to say in the case of an XPath node end, during the step 2509, the evaluation targets are deactivated that belong to the list of evaluation targets corresponding to the current depth of the evaluation target manager 1771, during a step 2800 illustrated in FIG. 28. The deactivation may consist either of removing those evaluation targets from the evaluation target stack, or of associating them with an “active”/“inactive” status which is, in this case, initialized to “inactive”. Next, during a step 2801, it is determined whether, from among the evaluation targets to deactivate, at least one corresponds to a root evaluation target (information carried by the type of the associated compiled navigation target). If yes, during a step 2802, a signal is sent to the parent location path (LocationPath) indicating that no solution has been found for the current evaluation context. This makes it possible to free the sub-expression awaiting XML data during the step 2404 and to send up an empty result during the steps 2406 to 2408 and, possibly, to output an evaluation result during the step 2409.

Next, during a step 2803, it is determined whether this propagation led to an end of evaluation. If yes, the evaluation terminates. Otherwise, during a step 2804, the current depth is decremented by “1”. During a step 2805, it is determined whether the current depth has the value “0”. If yes, the evaluation terminates since this means that the end of the XML data 1704 has been reached. Otherwise, during a step 2806, the evaluation targets located at the new current depth are reinitialized through use of the evaluation statuses and associated node test (NodeTest) statuses, for the purpose of an evaluation on new XML data during the step 2404 if step 2510 has nevertheless not determined that the end of evaluation has been reached.

The steps of FIG. 29 describe the preparation of the list of evaluation targets to verify for the next level of depth, which details, in particular, the steps 2503 and 2611. For this, the target manager 1771 retrieves, during a step 2900, the list of evaluation targets corresponding to the current depth level. The first evaluation target of that list of evaluation targets is then considered as the current evaluation target, during a step 2901. Next, the evaluation targets manager retrieves, during a step 2902, the compiled navigation target associated with the current evaluation target. Next, during a step 2903, it retrieves the list of the child compiled navigation targets of the compiled navigation target found during the step 2902. For each of those child compiled navigation targets, it creates an associated evaluation target, during the step 2904. Each evaluation target thus created is then inserted in the stack of targets of the target manager 1771, during a step 2905. At this time, each evaluation target created has a child-parent relationship which is initialized with the current evaluation target. The step of inserting a new evaluation target, during a step 2905, is dependent on the nature of its compiled navigation target and in particular on the value of the axis (AxisSpecifier). If the value of the axis is “descendant”, “ancestor” or “descendant-or-self” or else “ancestor-or-self”, the compiled navigation target is to be propagated for all the levels of depth encountered during the evaluation. If the value of the axis is “self”, “attribute” or “namespace”, the current evaluation target is to be inserted at the same level as the current target at the step 2905 and not at the next depth level.

Next, during a step 2906, a recipient that there might be is associated with each evaluation target. As a matter of fact, if, for a evaluation target created at the step 2904, the compiled navigation target is associated with a recipient which corresponds to a parent target, it is necessary to insert a recipient in the associated evaluation target. Otherwise, in the case of a recipient corresponding to a location path, the evaluation target obtains access thereto via its compiled navigation target and thus has no need for its own recipient. In the case of an evaluation target having its own recipient, this recipient corresponds to the first parent evaluation target of which the associated compiled navigation target is relevant. Once any recipient calculations have been carried out, the evaluation target manager 1771 proceeds to the following evaluation target in the list of current evaluation targets during a step 2907. If there is one, it becomes the current evaluation target during a step 2908 then the evaluation target manager repeats steps 2902 to 2907 until the end of the current evaluation target list is reached during the step 2907. Once the end of the list of evaluation targets has been reached during the step 2907, the evaluation target manager 1771 proceeds to step 2909, during which it determines whether, in the evaluation tree, for the current depth, compiled navigation targets remain which have not been processed. This makes it possible to process the case of the axes corresponding to ancestry relationships (“parent”, “ancestor” or “ancestor-or-self”). If the result of step 2909 is positive, the associated evaluation targets are created during a step 2910 and inserted in the list of current evaluation targets of the evaluation target manager 1771, during a step 2911. The recipients for those evaluation targets constructed in advance relative to their parent evaluation target will have their recipient updated when the associated compiled navigation target which is parent of their own associated compiled navigation target is processed during the step 2902. Further to step 2911 or if the result of step 2909 is negative, the step of preparing next evaluation targets terminates.

As may be understood from the reading of the preceding description, the implementation of the present invention provides a means for evaluating XPath expressions in a streaming environment. This is enabled by an analysis of those expressions in order to prepare and facilitate the management of the results since the processor must simultaneously process at least two location paths (LocationPaths), whether it is a matter of a single expression itself containing several location paths or several expressions to evaluate with respect to the same document. Furthermore, by the analysis of the expressions, the invention makes it possible to reduce the size of the internal representation on which the evaluation relies, while maintaining the simplicity of propagation of the results.

The advantages arising therefrom are reviewed here:

efficiency because the traversal of the XML document is a single traversal,

sending of the results as soon as they are calculated,

simple processing of the resulting XML nodes with a minimum storage,

efficient evaluation due to the factorization of calculations and the resolution of the AxisSpecifiers in advance,

re-usable analysis, the internal representation calculated a single time may be evaluated several times with respect to the same document or different documents and

the expression basis mixes function calls or operations with purely navigational expressions.

1- A method of analyzing an XPath expression composed of sub-expressions to evaluate with respect to a structured document, that comprises:
a step of classifying the sub-expressions of said expression into a subset comprising calculation sub-expressions and a subset comprising navigation sub-expressions and
a step of linking each navigation sub-expression to the calculation sub-expression that uses it.

2- A method according to claim 1, wherein the classifying step comprises a step of structuring each of the sub-sets of sub-expressions.

3- A method according to claim 2, wherein, during the structuring step, the subset comprising calculation sub-expressions are represented by an evaluation tree and the subset comprising navigation expressions are represented by a navigation tree.

4- A method according to claim 3, wherein, during the structuring step, the navigation tree is constituted with compiled navigation targets, which structure makes it possible to represent the search for information corresponding to said expression in the structured document, each compiled navigation target being inked to a navigation sub-expression of “LocationPath” type and to at least one “Step” in that “LocationPath”.

5- A method according to claim 4, wherein, during the structuring step each entity of “NodeTest” type of each “Step” is associated with at least one compiled navigation target.

6- A method according to claim 4, wherein, during the structuring step, it is determined whether a current compiled navigation target belongs to a new absolute or relative path, and, if yes, a new branch in the navigation tree is created.

7- A method according to claim 6, wherein, during the structuring step, it is determined whether the current compiled navigation target belongs to a new absolute or relative path and, if yes, a representation structure of a “LocationPath” is created as new leaf of the evaluation tree, this representation structure providing the link between the current branch of the evaluation tree and the new branch of the navigation tree.

8- A method according to claim 6, that comprises a step of creating an evaluation target associated with the current compiled navigation target, said evaluation target comprising information representing an evaluation status, a possible solution encountered during the evaluation and a link between the evaluation target and the current compiled navigation target.

9- A method according to claim 7, wherein, in the case of a “LocationPath” of which at least one “Step” contains at least one predicate, the evaluation tree descends as far as the “Step” entity in order to link the sub-expression corresponding to the predicate to its parent sub-expression, the current compiled navigation target being inserted at the start of that new branch and a link of that current compiled navigation target to the “LocationPath” from which it comes is updated as well as a type associated with that current compiled navigation target indicating that it represents the first “Step” of the path.

10- A method according to claim 3, wherein, during the classifying step, simplifications are made of the evaluation tree.

11- A method according to claim 1, wherein, during the classifying step, a grammatical analysis step is carried out during which a semantic parser goes through the list of tokens of the expressions and identifies the types of expression defined by the syntax linked to the XPath language contained in the expression to analyze.

12- A method according to claim 11, wherein, during the grammatical analysis step, for at least one token coming from a lexical analysis, determination is made, grammar rule by grammar rule, of whether the token satisfies said rule.

13. A method according to claim 12, wherein, during the grammatical analysis step, if the symbol satisfies a rule, it is determined whether said rule is linked to a navigation sub-expression and, if yes, a navigation sub-expression is constructed and, otherwise, a calculation sub-expression is constructed.

14- A method according to claim 1, wherein, during the classifying step, it is determined whether a sub-expression can contain other sub-expressions and, if yes, the representation of each said sub-expression comprises a reference to a parenthood link with at least one other sub-expression.

15- A method according to claim 1, wherein, during the classifying step, a generic representation structure is implemented for different types of calculation sub-expressions.

16- A method of evaluating an XPath expression with respect to a structured document in markup language, that implements the expression analyzing method according to claim 1 and comprises a step of evaluating the expression implementing the evaluation of the navigation sub-expressions of the expression relative to data of the structured document.

17- A method according to claim 16, wherein, during the step of evaluating the XPath expression, at least one calculation sub-expression and one navigation sub-expression are evaluated according to the following steps:
launching of the execution of the calculation sub-expressions by retrieving, from an evaluation tree representing the sub-set comprising calculation sub-expressions, what is denoted a “root” calculation expression and by going through what are denoted the “child” nodes until all the leaves of the evaluation tree have been reached.
going through the structured document to construct at least one result for each navigation sub-expression associated with a leaf calculation sub-expression of the evaluation tree,
sending each result of each navigation sub-expression to the associated calculation sub-expression,
and, iteratively until the root calculation sub-expression of the evaluation tree is reached:
applying processing linked to the calculation sub-expression on the result,
in case the calculation sub-expression is a child node, propagating the result of said processing to the parent calculation sub-expression.

18- A method according to claim 17, wherein, during the propagating step, if the parent calculation sub-expression has at least one calculation sub-expression not yet having undergone the step of applying processing, the iteration is suspended until each said child calculation sub-expression undergoes said step of applying processing.

19- A method according to claim 1, that further comprises:
a step of identifying at least one navigation sub-expression of at least one expression to evaluate, at least one said navigation sub-expression comprising at least one location path step,
a step of representing each said location path step of each said navigation sub-expression, in compiled navigation target form, which is a structure representing the search for information corresponding to said location path step in the structured document.
and, for each location path step:
a step of determining a recipient for the result of an evaluation of said location path step and
a step of adding an item of identification information of said recipient, to the compiled navigation target of said location path step.

20- A method according to claim 19, wherein, during the step of determining a recipient, determination is made of a compiled navigation target that is recipient for the result of an evaluation of said location path step.

21- A method according to claim 19, that comprises a step of organizing the compiled navigation targets according to their depth and a step of linking said compiled navigation targets to each other.

22- A method according to claim 19, wherein, during the linking step, branches of a navigation tree are constructed by the insertion of compiled navigation targets.

23- A method according to claim 22, wherein, during the inserting step, the current compiled navigation target is inserted in the navigation tree that represents the current location path, according to the value of the axis of the current compiled navigation target.

24- A method according to claim 19, that comprises a step of determining redundant intermediate compiled navigation targets and a step of merging redundant intermediate compiled navigation targets.

25- A method according to claim 19, wherein, during the representing step, entry is made in a field of the compiled navigation target to state therein which location path said compiled navigation target belongs to.

26- A method according to claim 19, wherein the representing step comprises:
a step of determining an axis value corresponding to the current location path step,
a step of identifying a node test which any node must satisfy that is a candidate for the resolution of the current location path step and
a step of identifying at least one predicate associated with the current location step.

27- A method according to claim 26, that comprises a step of grouping together compiled navigation targets on the basis of node tests associated with said compiled navigation targets.

28- A method according to claim 27, wherein, during the step of grouping together, for at least two compiled navigation targets corresponding to the same level of depth, it is determined whether the node tests have the same value and, if yes, one of the targets is updated with the values of child compiled navigation target links and any predicates, of the other compiled navigation target.

29- A method according to claim 26, wherein, if at least one predicate is identified, a link to the first compiled navigation target of each predicate is kept at the level of the current compiled navigation target.

30- A method according to claim 29, wherein, if at least one predicate is identified, the current compiled navigation target maintains a link to each sub-expression which corresponds to said predicate.

31- A method according to claim 19, wherein, to determine said recipient, it is determined whether there is a parent compiled navigation target and, if yes, it is determined whether that parent compiled navigation target contains at least one predicate and, if that parent compiled navigation target contains no predicate, the recipient for the results of the parent compiled navigation target becomes the recipient for the results of the current compiled navigation target.

32- A method according to claim 19, wherein, to determine said recipient, it is determined whether there is a parent compiled navigation target and, if yes, it is determined whether that parent compiled navigation target contains at least one predicate and, if yes, the parent compiled navigation target becomes the recipient for the results of the evaluation of the current compiled navigation target.

33- A method of evaluating at least one expression composed of sub-expressions to evaluate with respect to a structured document, that comprises the steps of the analysis method according to claim 19 and a step of evaluating each said expression using at least one said compiled navigation target incorporating an identification of the evaluation result recipient for a location path step of a navigation sub-expression of a said expression.

34- A method according to claim 33, wherein, during the evaluating step, an evaluation is carried out in a streaming environment.

35- A method according to claim 33, that comprises a step of generating evaluation targets, with a compiled navigation target corresponding to at least one evaluation target which bears the information relative to the status of the execution.

36- A method according to claim 35, wherein, during the evaluating step, a node test is retrieved depending on the content of a compiled navigation target associated with the current evaluation target and furthermore a node is retrieved and it is determined whether said node satisfies said node test.

37- A method according to claim 36, wherein, during the evaluating step, if an evaluation target is resolved and if said evaluation target is a leaf of a navigation tree, the current node is propagated to the recipient associated with the current evaluation target.

38- A method according to claim 33, wherein, during the evaluating step, if a recipient evaluation target, other than the root of a navigation tree, receives a solution XML node, the latter is used for the resolution of said evaluation target and, if that XML node enables a result to be obtained for that evaluation target, that result is sent to the recipient target associated with the current evaluation target.

39- A device for analyzing an XPath expression composed of sub-expressions to evaluate with respect to a structured document, that comprises:
a means for classifying the sub-expressions of said expression into a subset comprising calculation sub-expressions and a subset comprising navigation sub-expressions and
a means for linking each navigation sub-expression to the calculation sub-expression that uses it.

40- A device according to claim 39, that comprises:
a means for identifying at least one navigation sub-expression of at least one expression to evaluate, at least one said navigation sub-expression comprising at least one location path step,
a means for representing each said location path step of each said navigation sub-expression, in the form of a compiled navigation target,
a means for determining a recipient for the result of an evaluation of each location path step and
a means for adding an item of identification information of said recipient, to the compiled navigation target of said location path step.

41- A device for evaluating at least one expression composed of sub-expressions to evaluate with respect to a structured document, that comprises a device according to claim 40 and a means for evaluating each said expression using at least one of said compiled navigation targets incorporating an identification of the evaluation result recipient for a location path step of a navigation sub-expression of a said expression.

42- A computer program that can be loaded into a computer system, said program containing instructions enabling the implementation of the analyzing method according to claim 1.

43- A removable or non-removable carrier for computer or microprocessor readable information, storing instructions of a computer program, that makes it possible to implement the analyzing method according to claim 1.
